(19) United States
(12) Patent Application Publication
(10) Pub. No.: US 2009/0248804 A1
(43) Pub. Date: Oct. 1, 2009

(54) ACCESS REQUEST TRANSFER SYSTEM, ACCESS REQUEST TRANSFER METHOD, AND RECORDING MEDIUM STORING ACCESS REQUEST TRANSFER PROGRAM

(75) Inventor: Takeshi Ohtani, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/406,676

(22) Filed: Mar. 18, 2009

(30) Foreign Application Priority Data
Mar. 31, 2008 (JP) 2008-92975

(51) Int. Cl. G06F 15/173; G06F 15/16

(52) U.S. Cl. 709/204; 709/225

(57) ABSTRACT

A proxy server is communicably connected to another server. An association storage unit stores proxy information and server information. A determination unit determines, when an access request transmitted by the client is received, whether or not the server specified by the access request is actually accessible. A first access request transfer unit, when the server specified by the access request is determined to be actually inaccessible, searches the association storage unit using the server information identifying the server specified by the access request and transfers the access request to the proxy server identified by the proxy information associated with the server information. A second access request transfer unit, when the server specified by the access request is determined to be actually accessible, transfers the access request to the server specified by the access request.

### CROSS-REFERENCE TO RELATED APPLICATIONS

This application is based upon and claims the benefit of priority of the prior Japanese Patent Application No. 2008-092975, filed on Mar. 31, 2008, the entire contents of which are incorporated herein by reference.

### FIELD

The embodiments discussed herein are related to access request transfer.

### BACKGROUND

There is a system in which, when a client accesses a server, the client accesses the server via a proxy server preset by a user who uses the client. In such a system, there are some cases when, for example, the server cannot be accessed from the preset proxy server (for example, when a network fails). Therefore, in such a system, a plurality of techniques have been known to change the proxy server to be used by the client.

For example, a technique to manually change the proxy server is known. To cite a concrete example, a technique to manually change the proxy server used by the client by changing settings of the client by a user who uses the client is known.

Also, a technique to automatically change the proxy server is known. To cite a concrete example, a technique to automatically select and change the proxy server in accordance with a network to be used is known. In addition, a technique to automatically change the proxy server used for each server (URL (Uniform Resource Locator)) by the client is known. Also, Patent Document 1 discloses a technique to automatically change the proxy server from one to another, when a communication load of the proxy server increases.

[Patent Document 1] Japanese Laid-open Patent Publication No. 2002-271415 (pp. 5 to 12, FIG. 1)

However, that the server cannot be accessed from another proxy server without settings of the client being changed.

According to the technique to manually change the proxy server, the client accesses the server via the proxy server preset by an administrator managing the client. Here, if it becomes impossible for the client to access the server from the preset proxy server (for example, because the network fails), the administrator changes the proxy server to another proxy server (a proxy server capable of accessing the server). Subsequently, the client accesses the server. Thus, according to the technique to manually change the proxy server, the server cannot be accessed from another proxy server without settings of the client being changed.

According to the techniques to automatically change the proxy server, settings cannot be changed in accordance with the access status (whether or not the server is accessible) to the server. That is, if it becomes impossible for the client to access the server from the preset proxy server, settings cannot be changed in accordance with the access status. Thus, according to the techniques to automatically change the proxy server, the server cannot be accessed from another proxy server without settings of the client being changed.

The technology to be disclosed has been developed to solve the above problems of conventional technology and an object thereof is to provide a technology concerning access request transfer capable of accessing the server from another proxy server without settings of the client being changed.

### SUMMARY

A proxy server is communicably connected to another server. An association storage unit stores proxy information accumulated on the server as information for identifying the proxy server and received from the server or another proxy server together with an access response responding to an access request and server information identifying the server specified by the access request by associating the server information and the proxy information. A determination unit determines, when the access request transmitted by the client is received, whether or not the server specified by the access request is actually accessible. A first access request transfer unit, when the server specified by the access request is determined to be actually inaccessible by the determination unit, searches the association storage unit using the server information identifying the server specified by the access request, and transfers the access request to the proxy server identified by the proxy information associated with the server information. A second access request transfer unit, when the server specified by the access request is determined to be actually accessible by the determination unit, transfers the access request to the server specified by the access request.

### BRIEF DESCRIPTION OF THE DRAWINGS

Embodiments are illustrated by way of example and not limited by the following figures.

FIG. 1 illustrates a block diagram of an overview of an access request transfer system;

FIG. 2 illustrates an example of the configuration of the access request transfer system;

FIG. 3 illustrates an example of information stored in an association storage part;

FIG. 4 illustrates an example of information stored in an access storage part;

FIG. 5 illustrates an example of information stored in a policy storage part;

FIG. 6 illustrates an example of information stored in a proxy storage part;

FIG. 7 illustrates an example of a connection response from a server;

FIG. 8A illustrates a sequence diagram of an example of a flow of information under normal conditions;

FIG. 8B illustrates a sequence diagram of an example of the flow of information under abnormal conditions;

FIG. 9 illustrates a flowchart of an example of the flow of processing of the access request transfer system;

FIG. 10 illustrates a block diagram of an example of the configuration of an access request transfer system;

FIG. 11 illustrates an example of the flow of information under normal conditions;

FIG. 12 illustrates an example of the flow of information under abnormal conditions;

FIG. 13A illustrates a program of the access request transfer system; and

FIG. 13B illustrates the program of the access request transfer system.

### DESCRIPTION OF EMBODIMENTS

Embodiments will be described below in detail with reference to the attached drawings. An overview of an access request transfer system according to a first embodiment is first provided and the configuration of the access request transfer system and the flow of processing are described in turn and then, other embodiments are described.

### First Embodiment

### Overview of the Access Request Transfer System

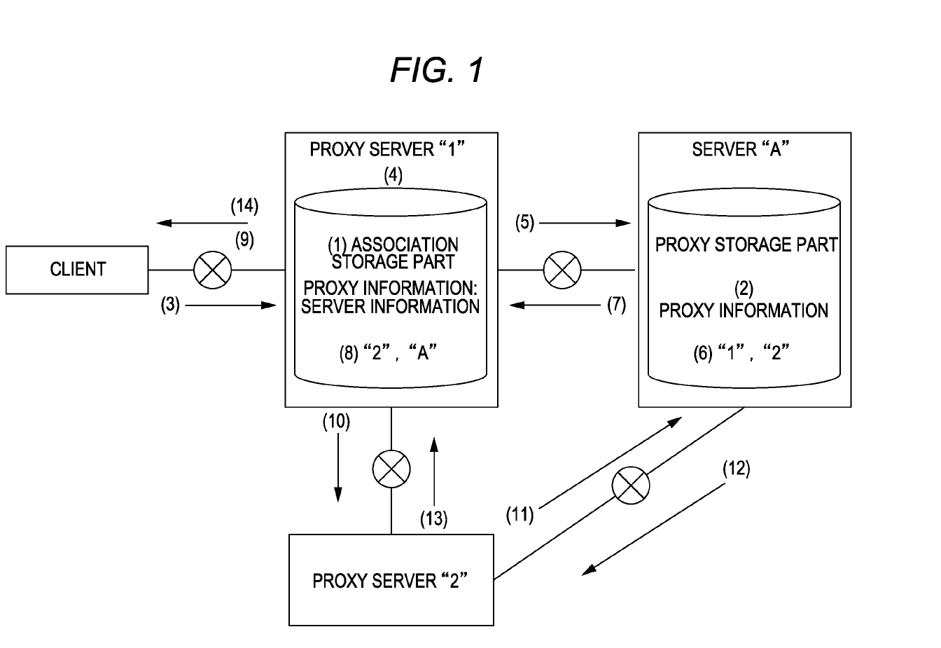

First, an overview of the access request transfer system according to the first embodiment will be provided using FIG. 1. FIG. 1 illustrates an overview of the access request transfer system according to the first embodiment.

As shown in FIG. 1, the access request transfer system according to the first embodiment includes a plurality of proxy servers, a server, and a client. The plurality of proxy servers, the server, and the client are connected via a network. Here, the access request transfer system according to the first embodiment transfers an access request transmitted from the client (user terminal) to the server specified by the access request as the access destination via a proxy server. The access request corresponds, for example, to a request to transmit/receive information to/from a specific server.

The access request transfer system according to the first embodiment will be described assuming that the system has one client and a plurality of proxy servers (a proxy server “1” and a proxy server “2” in the example shown in FIG. 1). Also, the access request transfer system according to the first embodiment has a plurality of servers and, an example in which an access request that requests transmission/reception of information to/from one of the servers (a server “A” in the example shown in FIG. 1) is transmitted by the client will be described.

Moreover, as will be described below, the access request transfer system according to the first embodiment is capable of accessing the server from another proxy server without settings of the client being changed.

A case when the server is accessible from the proxy server “1” will first be described below and then, a case when the server is not accessible from the proxy server “1” will be described.

### When the Server is Accessible

First, the case when the server is accessible from the proxy server “1” will be described. In the access request transfer system according to the first embodiment, as shown in (1) of FIG. 1, the proxy server has an association storage part in which “server information” identifying a server and “proxy information” identifying a proxy server are associated and stored.

In the access request transfer system according to the first embodiment, as shown in (2) of FIG. 1, the server has a proxy storage part storing proxy information.

In the access request transfer system according to the first embodiment having the server and the proxy server with such a storage part, as shown in (3) of FIG. 1, the client transmits an access request to the server to the proxy server “1”. For example, the client transmits an access request to transmit/receive information to/from the server “A” to the proxy server “1”.

Then, in the access request transfer system according to the first embodiment, as shown in (4) of FIG. 1, the proxy server receives the access request from the client. The proxy server that has received the access request determines whether or not the server specified by the access request is actually in an accessible state. To describe by using the example in FIG. 1, the proxy server “1” determines whether or not the server “A” is accessible.

If, in (4) of FIG. 1, the proxy server determines that the server specified by the access request is actually in an accessible state, the proxy server transfers, as shown in (5) of FIG. 1, the access request to the server specified by the access request. For example, the proxy server “1” transfers the access request received from the client to the server “A”.

Then, after the transferred access request from the proxy server is received, as shown in (6) of FIG. 1, the server stores proxy information identifying the proxy server in the proxy storage part. In the example shown in (6) of FIG. 1, for example, the server “A” receives the access request from the proxy server “1”. Then, the server “A” stores proxy information “1” identifying the proxy server “1” in the proxy storage part.

In this manner, a server stores proxy information identifying proxy servers that can access the server in the proxy storage part. Proxy information “2” is stored in the proxy storage part by the same processing as that used for the proxy information “1”. For example, after an access request transferred from the proxy server “2” is received, the server “A” stores the proxy information “2” in the proxy storage part.

Then, in the access request transfer system according to the first embodiment, as shown in (7) of FIG. 1, the server reads proxy information stored in the proxy storage part from the proxy storage part. Then, the server transmits the read proxy information to the transfer source of the access request together with an access response to the access request.

For example, the server “A” reads the proxy information “2” from the proxy storage part. Then, the server “A” transmits the proxy information “2” to the proxy server “1” together with an access response.

Then, in the access request transfer system according to the first embodiment, as shown in (8) of FIG. 1, the proxy server receives the proxy information from the server together with the access response. Then, in the access request transfer system according to the first embodiment, the proxy server associates server information identifying the server specified by the access request and the proxy information and stores the associated information in the association storage part.

An example in which, for example, the proxy server receives the proxy information “2” from the server “A” is taken to describe more specifically. The proxy server “1” stores the proxy information “2” received from the server “A” in the association storage part in association with server information “A”.

In this manner, the proxy server receives from a server proxy information identifying proxy servers that can access the server. Then, the proxy server accumulates, in the association storage part, proxy information identifying proxy servers that can access the server, the information being received by the server identified by server information for each piece of the server information.

Then, in the access request transfer system according to the first embodiment, as shown in (9) of FIG. 1, the proxy server transfers to the client the access response received from the server.

### When the Server is not Accessible

Next, the case in which the server “A” is not accessible from the proxy server “1” will be described. It is assumed in the access request transfer system according to the first embodiment that the association storage part associates and stores, as shown in (1) of FIG. 1, the proxy information (2) and the server information “A”.

In the access request transfer system according to the first embodiment, as shown in (4) of FIG. 1, the proxy server determines that the server specified by the access request is not in an accessible state. Then, in the access request transfer system according to the first embodiment, the proxy server searches the association storage part using server information identifying the server specified by the access request. Then, as shown in (10) of FIG. 1, the access request is transferred to a proxy server identified by proxy information stored in association with the server information.

If, for example, the proxy server “1” determines that the server “A” is not in an accessible state, the proxy server “1” searches the association storage part. Then, the proxy server “1” reads the proxy information “2” associated with the server information “A” from the association storage part. Then, the proxy server “1” transfers the access request received from the client to the proxy server “2”.

Then, in the access request transfer system according to the first embodiment, as shown in (11) of FIG. 1, the proxy server “2” transfers the access request received from the proxy server “1” to the server “A”.

Then, in the access request transfer system according to the first embodiment, as shown in (12) to (14) of FIG. 1, an access response is transmitted from the server “A” to the client via the proxy server “2”.

Thus, an access request transfer system according to the first embodiment can access, as described above, the server from another proxy server without settings of the client being changed.

### Configuration of the Access Request Transfer System

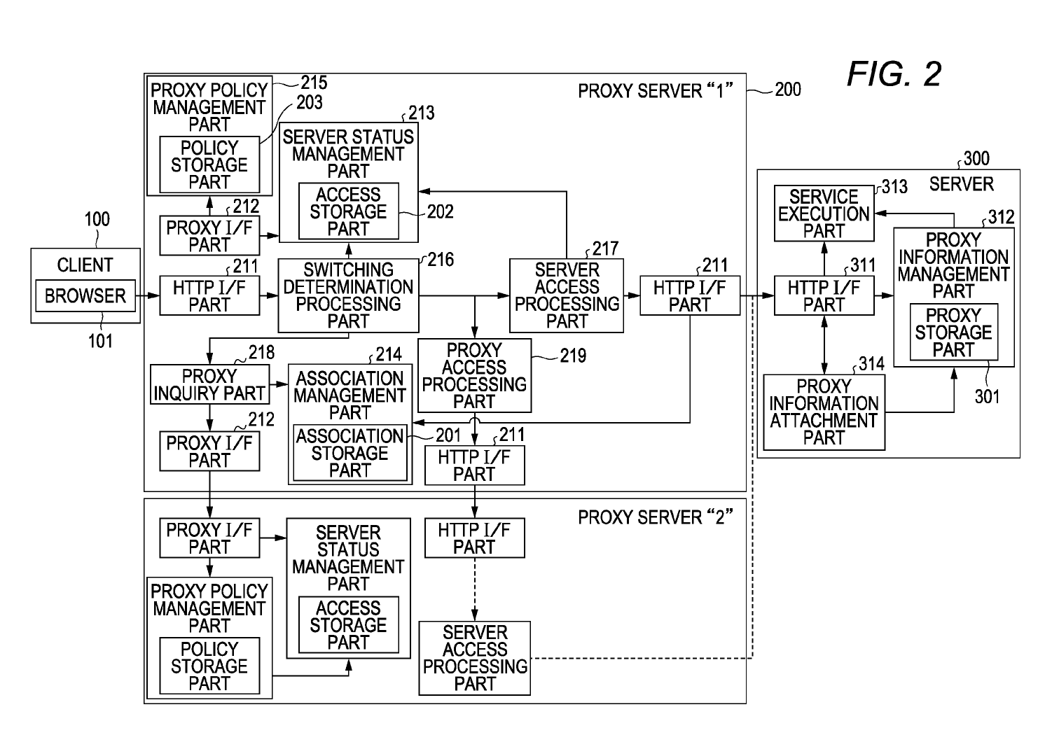

Next, the configuration of the access request transfer system shown in FIG. 1 will be described using FIG. 2. The configuration of a client is first described below and then, that of a proxy server is described. Subsequently, the configuration of a server is described. FIG. 2 illustrates a block diagram of an example of the configuration of the access request transfer system according to the first embodiment.

It is assumed below that the access request transfer system has one client 100 and two proxy servers 200. The access request transfer system has a plurality of servers and an example in which an access request that requests transmission/reception of information to/from one of the servers 300 (the server “A” in FIG. 1) is transmitted by the client 100 will be described.

For convenience of description, numbers like “1” and “2” or alphabetical characters like “A” and “B” will be used below as proxy information identifying each of the proxy servers 200 and the server 300. As server information identifying the server 300, an address, a domain name or the like is actually used.

It is also assumed that each of the plurality of proxy servers 200 contained in the access request transfer system has the same configuration and similar functions. Incidentally, in the example shown in FIG. 2, the configuration of the two proxy servers, the proxy server “1” and the proxy server “2”, is shown to show relations between the proxy servers, but for convenience of description, only a portion of the configuration held by the proxy server “1” is shown for the proxy server “2”.

It is also assumed that the proxy server 200 described below transfers an access request to the other proxy server 200 and has an access request transferred thereto by the other proxy server 200. Similarly, it is assumed that the proxy server 200 described below transfers a confirmation request (described later) or determination results (described later) to the other proxy server 200 and receives a confirmation request (described later) or determination results (described later) from the other proxy server 200.

In a description that follows, when an example is used for description, focus is on the proxy server “1”. For example, when an access request is transferred from one proxy server 200 to the other proxy server 200, it is assumed that the proxy server “1” transfers the access request to the proxy server “2”. Similarly, when one proxy server 200 has an access request transferred thereto by the other proxy server 200, it is assumed that the proxy server “1” has the access request transferred thereto by the other proxy server “2”.

### Client

First, the client 100 will be described. The client 100 is connected to the proxy servers 200 via a network. The client 100 has a browser 101.

The browser 101 transmits an access request to the proxy servers 200 via the network. More specifically, the browser 101 has proxy information identifying the proxy server 200 to be used stored in advance therein. The proxy information is stored in the browser 101 in advance, for example, by an administrator managing the client 100. The browser 101 transmits an access request to the proxy server 200 identified by the proxy information stored in advance.

An example in which the browser 101 stores the proxy information “1” in advance is taken for a description below. After an instruction to transmit an access request to transmit/receive information to/from the server “A” is input by a user using the client 100, the browser 101 transmits the access request to the proxy server “1”.

### Proxy Server

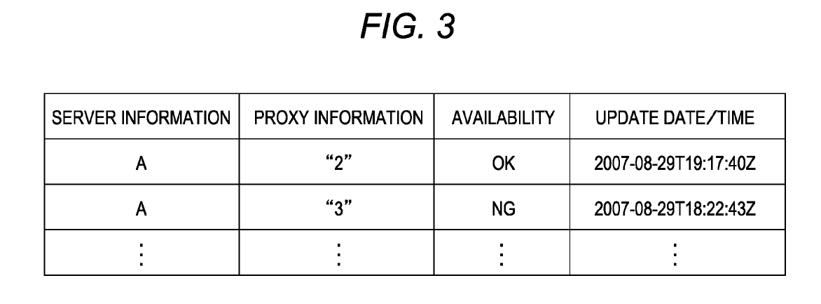

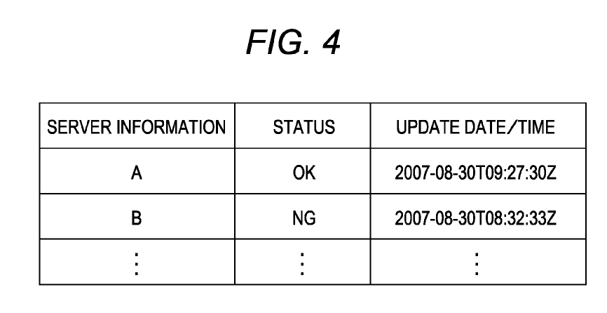

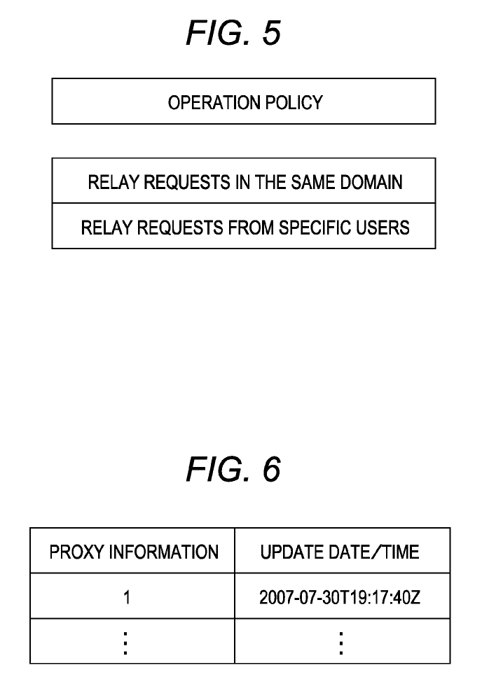

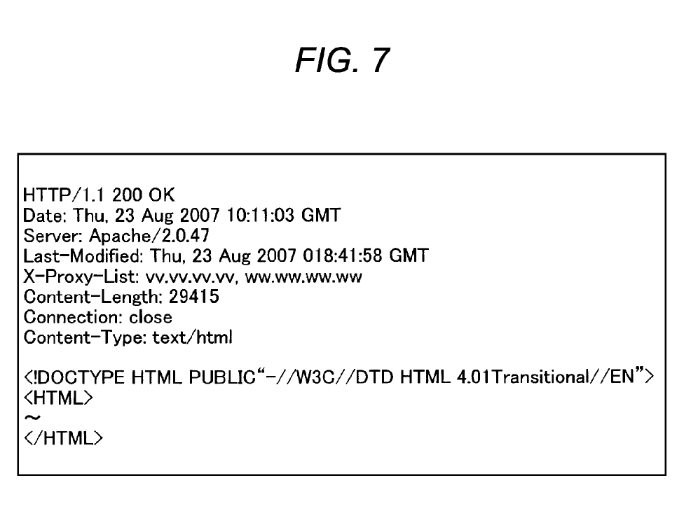

Next, the proxy server 200 will be described using FIGS. 3 to 7. FIG. 3 illustrates an example of information stored in an association storage part in the first embodiment. FIG. 4 illustrates an example of information stored in an access storage part in the first embodiment. FIG. 5 illustrates an example of information stored in a policy storage part in the first embodiment. FIG. 6 illustrates an example of information stored in a proxy storage part in the first embodiment. FIG. 7 illustrates an example of an access response from a server in the first embodiment.

The proxy server 200 is connected to the client 100 and the server 300 via a network. The proxy server 200 is connected to the other proxy server 200 via the network. For example, the proxy server “1” is connected to the proxy server “2” via the network. The proxy server 200 receives an access request transmitted from the client 100 to the server 300 and transfers the received access request to the server 300 or the other proxy server 200. The proxy server 200 also receives an access response transmitted from the server 300 to the client 100 and transfers the received access response to the client 100 or the other proxy server 200.

The proxy server 200 has an association storage part 201, an access storage part 202, and a policy storage part 203.

The association storage part 201 associates and stores server information identifying the server and proxy information identifying the other proxy server. For example, as shown in FIG. 3, the association storage part 201 stores “Proxy information”, “Availability”, and “Update date/time” indicating the update date/time in association with “Server information”. “Availability” is information indicating whether or not the proxy server identified by “Proxy information” can transfer an access request to the server 300 identified by “Server information”.

For example, access from persons not concerned may not be permitted as an operation policy of the proxy server 200. “Availability” is used as information so that when an access request from the client 100 is transferred to the other proxy server 200, a proxy server that does not permit access is not selected as a candidate as an access request transfer destination.

To describe by taking a concrete example, the association storage part 201 stores the proxy information “2”, the availability “OK” of the proxy server identified by the proxy information “2”, and the update date/time “2007-08-29T19:17:40 Z” in association with the server information “A”.

The first embodiment is described, as shown in FIG. 3, by taking an example in which the association storage part 201 stores “Proxy information”, “Availability”, and “Update date/time” in association with “Server information”, but the present invention is not limited to this. For example, the association storage part 201 may store only “Proxy information” in association with “Server information”. Alternatively, for example, the association storage part 201 may store “Proxy information” and one of “Availability” and “Update date/time” in association with “Server information”.

Information is stored in the association storage part 201 by an association management part 214 described later. In addition, information stored in the association storage part 201 is used by the association management part 214 described later.

The access storage part 202 stores information indicating for each server whether or not the server is in an accessible state. For example, as shown in FIG. 4, the access storage part 202 stores “Status”, which is information indicating whether or not the server identified by Server information is actually in an accessible state and “Update date/time” in association with “Server information”.

To describe by taking a concrete example, the access storage part 202 stores the status “OK” and the update date/time “2007-08-30T09:27:30 Z” in association with the server information “A”.

The first embodiment is described, as shown in FIG. 4, by taking an example in which the access storage part 202 stores “Status” and “Update date/time” in association with “Server information”, but the present invention is not limited to this. For example, the access storage part 202 may store only “Status” in association with “Server information”.

Information is stored in the access storage part 202 by a server status management part 213 described later. In addition, information stored in the access storage part 202 is used by the server status management part 213 described later.

The policy storage part 203 stores policies used for operation of the proxy server 200. For example, as shown in FIG. 5, the policy storage part 203 stores, as an example of policy, “Relay requests (access requests) in the same domain” and also “Relay requests from specific users (for example, the client 100 or the proxy server 200)”.

The policy storage part 203 has policies stored in advance therein by an administrator managing the proxy server 200. Policies stored in the policy storage part 203 are also used by a proxy policy management part 215 described later when a confirmation request (described later) is transmitted from the other proxy server.

Here, a difference between information stored in the association storage part 201 and that stored in the access storage part 202 will briefly be described.

First, information stored in the association storage part 201 is information about the other proxy server 200 than the proxy server 200 on which the association storage part 201 is installed. More specifically, the association storage part 201 stores the server 300 accessible from the other proxy server 200 for each of the other proxy servers 200.

In contrast, information stored in the access storage part 202 is information about the proxy server 200 on which the access storage part 202 is installed. More specifically, the access storage part 202 stores whether or not each of the servers 300 is accessible from the proxy server 200 on which the access storage part 202 is installed.

Next, a difference between “Availability” stored in the association storage part 201 and “Status” stored in the access storage part 202 will briefly be described. “Status” is information indicating whether or not the server 300 is actually accessible from the proxy server 200 on which the access storage part 202 is installed. If, for example, there is no network failure between the proxy server 200 and the server 300 and the server 300 is actually accessible from the proxy server 200, “Status” becomes “OK”. If the server 300 is not actually accessible from the proxy server 200, “Status” becomes “NG”. On the other hand, “Availability” stored in the association storage part 201 indicates whether or not an access request can be transferred, from the proxy server 200 on which the association storage part 201 is installed, to the other proxy server 200 associated with “Availability”. If, for example, an access request can be transferred to the other proxy server 200 associated with “Availability”, “Availability” becomes “OK” and if an access request cannot be transferred, “Availability” becomes “NG”.

To describe by taking a concrete example, the proxy server “1” stores the availability “NG” in association with the proxy information “2” in the association storage part 201 in cases shown below. This is, for example, when the proxy server “2” does not, based on a policy set to the proxy server “2”, permit transfer (relay) of an access request from the proxy server “1”. In this case, the availability stored in the association storage part 201 becomes “NG” even if the server 300 specified by the access request is actually accessible from the proxy server “2”.

The proxy server 200 has an HTTP I/F (proxy server) part 211, a proxy I/F part 212, a server status management part 213, an association management part 214, a proxy policy management part 215, a switching determination processing part 216, a server access processing part 217, a proxy inquiry part 218, and a proxy access processing part 219 as control parts to perform predetermined processing.

The association management part 214 is one example used in an “association storage procedure” in the claims. The switching determination processing part 216 and the server status management part 213 are examples used in a “determination procedure”. The switching determination processing part 216, the proxy inquiry part 218, and the proxy access processing part 219 are examples used in a “first access request transfer procedure”. The switching determination processing part 216 and the server access processing part 217 are examples used in a “second access request transfer procedure”. The server status management part 213 is an example used in an “access information storage procedure” claim. The proxy inquiry part 218 and the association management part 214 are examples used in a “confirmation request transmission procedure” claim and a “determination result storage procedure” respectively.

The HTTP I/F (proxy server) part 211 receives an access request from the browser 101. Then, the HTTP I/F (proxy server) part 211 delivers the received access request to the switching determination processing part 216.

When an access request is received from the server access processing part 217, the HTTP I/F (proxy server) part 211 also transfers the access request to the server 300. Also, the HTTP I/F (proxy server) part 211 receives an access response (and proxy information transmitted together with the access response) transmitted from the server 300 and delivers the received access response to the server access processing part 217.

When an access response is received from the proxy access processing part 219, the HTTP I/F (proxy server) part 211 also transfers the access response to the other proxy server 200. Also, the HTTP I/F (proxy server) part 211 receives an access response transmitted from the other proxy server 200 and delivers the received access response to the server access processing part 217.

After a confirmation request from the other proxy server 200 is received, the proxy I/F part 212 delivers the received confirmation request to the proxy policy management part 215. The proxy I/F part 212 also transmits a determination result regarding the confirmation request delivered from the proxy policy management part 215 to the other proxy server 200.

Also, the proxy I/F part 212 delivers a confirmation request delivered from the proxy inquiry part 218 to the other proxy server 200. The proxy I/F part 212 also transmits a determination result regarding the confirmation request transmitted from the other proxy server 200 to the proxy policy management part 215.

A confirmation request is a request to confirm whether or not an access request is transferable to the server specified by the access request. A determination result regarding a confirmation request is a result determined by the proxy server 200 that received a confirmation request whether or not an access request from the proxy server 200 that transmitted the confirmation request is actually transferable to the server specified by the access request.

The server status management part 213 manages the access storage part 202 and also determines whether or not the server 300 is actually accessible.

First, what relates to management of the access storage part 202 will be described more specifically. The server status management part 213 manages an association between “Server information” and “Status” stored in the access storage part 202.

Information to the effect that an access response responding to an access request has normally been received is delivered from the server access processing part 217 to the server status management part 213. Then, the server status management part 213 associates server information identifying the server specified by the access request and information indicating that the server is actually accessible before the server information and the latter information are stored in the access storage part 202. A concrete description will be given by using the example shown in FIG. 4. When an access response from the server “A” is delivered from the server access processing part 217, the server status management part 213 associates the server information “A” and the status “OK” before the server information and the status are stored in the access storage part 202.

Information to the effect that no access response responding to an access request has been received is delivered from the server access processing part 217 to the server status management part 213. Then, the server status management part 213 associates server information identifying the server specified by the access request and information indicating that the server is actually inaccessible before the server information and the latter information are stored in the access storage part 202. A concrete description will be given by using the example shown in FIG. 4. When information to the effect that no access response from the server “B” has been received is delivered from the server access processing part 217, the server status management part 213 associates the server information “B” and the status “NG” before the server information and the status are stored in the access storage part 202.

When the server status management part 213 has a message, to the effect that an access response from the server 300 is not normal, delivered from the server access processing part 217, the server status management part 213 updates “Status” associated with server information identifying the server 300 to “NG”.

When storing association between server information and status in the access storage part 202, the server status management part 213 stores “Update date/time” in association with the association. For example, when the server information “A” and the status “OK” are associated for storage in the access storage part 202, the server status management part 213 further associates the update date/time “2007-08-30T09:27:30 Z” with the association for storage.

Next, what relates to a determination whether or not the server 300 is actually accessible will be described more specifically. When the server status management part 213 has an instruction to determine whether or not the server 300 specified by an access request is actually accessible delivered by the switching determination processing part 216, the server status management part 213 determines whether or not the server 300 is actually accessible. Then, the server status management part 213 delivers a determination result about the server 300 to the switching determination processing part 216.

More specifically, the server status management part 213 uses the association between “Server information” and “Status” stored in the access storage part 202 for the determination. For example, the server status management part 213 determines whether or not information indicating that the server 300 is actually accessible is stored in the access storage part 202 in association with server information indicating the server 300 specified by an access request. To describe by taking a concrete example, the server status management part 213 determines whether or not the status stored in the access storage part 202 is “OK”. Then, if information indicating that the server 300 is actually accessible is stored in the access storage part 202, the server status management part 213 determines that the server 300 is accessible. If, for example, information indicating that the server 300 is actually accessible is not stored in the access storage part 202, the server status management part 213 determines that the server 300 is inaccessible. Then, the server status management part 213 delivers a determination result about the server 300 to the switching determination processing part 216.

A concrete description will be given by using the example shown in FIG. 4. When the server status management part 213 makes a determination about the server “A”, for example, the server status management part 213 determines that the server “A” is accessible because an association between the server information “A” and the status “OK” is stored in the access storage part 202. On the other hand, when the server status management part 213 makes a determination about the server “B”, for example, the server status management part 213 determines that the server “B” is inaccessible because an association between the server information “B” and the status “NG” is stored in the access storage part 202. Then, the server status management part 213 delivers a determination result (for example, “NG” or “OK”) about the server 300 to the switching determination processing part 216.

The association management part 214 manages the association storage part 201 and responds to an inquiry from the proxy inquiry part 218.

First, what relates to management of the association storage part 201 will be described more specifically. More specifically, the association management part 214 stores, in the association storage part 201, an association between proxy information and server information delivered from the server access processing part 217. Also more specifically, the association management part 214 associates “Availability” delivered from the proxy inquiry part 218 with the association between proxy information and server information stored in the association storage part 201 and stores “Availability” in the association management part 214.

To describe by using the example in FIG. 3, for example, when the server information “A” and the proxy information “2” are delivered from the server access processing part 217, the association management part 214 stores an association between the server information “A” and the proxy information “2” in the association storage part 201.

After the association between the “server information” and “proxy information” delivered from the server access processing part 217 is newly stored in the association storage part 201, the association management part 214 delivers the association to the proxy inquiry part 218. The association management part 214 checks whether or not any association containing proxy information is present (stored) in the association storage part 201 and if no association is present in the association storage part 201, the association management part 214 delivers the association to the proxy inquiry part 218.

When the association management part 214 has information associated with “Availability” delivered from the proxy inquiry part 218 together with association delivered to the proxy inquiry part 218, the association management part 214 stores the association among the delivered “Server information”, “Proxy information”, and “Availability” in the association storage part 201.

When the association between “Server information” and “Proxy information” or that among “Server information”, “Proxy information”, and “Availability” is stored in the association storage part 201, the association management part 214 stores “Update date/time” in association with the association. For example, when the server information “A”, the proxy information “2”, and the availability “OK” are associated and stored in the association storage part 201, the association management part 214 stores the update date/time “2007-08-29T19:17:40 Z” in association with the association.

Next, what relates to an inquiry from the proxy inquiry part 218 will be described. More specifically, the association management part 214 has information to the effect that an inquiry will be made and server information delivered from the proxy inquiry part 218. Then, the association management part 214 acquires “proxy information” to identify the proxy server actually accessible to the server identified by the server information from the association storage part 201 and delivers the “proxy information” to the proxy inquiry part 218.

For example, the association management part 214 has information to the effect that an inquiry will be made and the server information “A” delivered from the proxy inquiry part 218. Then, the association management part 214 acquires the proxy information “2” associated with the server information “A” and the availability “OK” by searching the association storage part 201, and delivers the proxy information “2” to the proxy inquiry part 218.

The proxy policy management part 215 determines whether or not an access request can be transferred. More specifically, the proxy policy management part 215 determines whether or not the proxy server 200 that received a confirmation request can actually transfer an access request from the proxy server 200 that transmitted the confirmation request to the server 300 specified by the access request. When the proxy policy management part 215 has a confirmation request (described later) transmitted from the other proxy server, the proxy policy management part 215 performs processing thereon.

A detailed description of the determination will be provided. The proxy policy management part 215 has a confirmation request from the other proxy server 200 delivered from the proxy I/F part 212. Then, the proxy policy management part 215 makes a determination using policies stored in the policy storage part 203 and also makes a determination using associations between “Server information” and “Status” stored in the access storage part 202.

The proxy policy management part 215 makes a determination using policies stored in the policy storage part 203. This will be described by taking an example in which the proxy server “1” receives a confirmation request from the proxy server “2”. The proxy policy management part 215 makes a determination of permission when, for example, an access request from the proxy server “2” is an access request from the same domain as that of the proxy server “1” (See FIG. 5).

The proxy policy management part 215 also makes a determination using associations between “Server information” and “Status” stored in the access storage part 202. An example will now be described in which the proxy server “1” receives, from the proxy server “2”, a confirmation request to determine whether or not an access request is transferable to the server “A”. The proxy policy management part 215 makes a determination of permission when the status “OK” is stored in the access storage part 202 by being associated with the server information “A”. The proxy policy management part 215 makes a determination of non-permission when the status “NG” is stored in the access storage part 202 by being associated with the server information “A”.

When a determination of permission is made using policies stored in the policy storage part 203 and also a determination of permission is made using the association between “Server information” and “Status” stored in the access storage part 202, the proxy policy management part 215 determines that an access request can be transferred. That is, an access request is acceptable. When one or both of a determination using policies stored in the policy storage part 203 and that using the association between “Server information” and “Status” stored in the access storage part 202 are non-permission, the proxy policy management part 215 determines that an access request cannot be transferred. That is, an access request is not acceptable.

The proxy policy management part 215 also transfers a determined determination result to the proxy I/F part 212.

When an access request is delivered from the HTTP I/F (proxy server) part 211, the switching determination processing part 216 delivers the access request to the server status management part 213 or the proxy access processing part 219.

More specifically, the switching determination processing part 216 determines whether or not the server 300 specified by the access request is actually accessible. Then, if the server 300 specified by the access request is actually accessible, the switching determination processing part 216 transmits the access request to the server status management part 213. If the server 300 specified by the access request is actually inaccessible, the switching determination processing part 216 transmits the access request to the proxy access processing part 219.

Here, what relates to a determination whether or not the server 300 specified by an access request is actually accessible will be described. When an access request is delivered from the HTTP I/F (proxy server) part 211, the switching determination processing part 216 delivers the access request to the server status management part 213. Then, the switching determination processing part 216 has a determination result indicating whether or not the server 300 specified by the access request is actually accessible delivered from the server status management part 213.

The switching determination processing part 216 has an access request to transmit/receive information to/from the server “A” delivered from the HTTP I/F (proxy server) part 211. Then, the switching determination processing part 216 delivers the access request to the server status management part 213.

The switching determination processing part 216 also has information to the effect that the server “A” is actually accessible (for example, “OK”) or information to the effect that the server “A” is actually inaccessible (for example, “NG”) delivered from the server status management part 213. Then, if information to the effect that the server “A” is actually accessible (for example, “OK”) is delivered from the server status management part 213, the switching determination processing part 216 determines that the server “A” is actually accessible. If information to the effect that the server “A” is actually inaccessible (for example, “NG”) is delivered from the server status management part 213, the switching determination processing part 216 determines that the server “A” is actually inaccessible.

Next, a case in which the switching determination processing part 216 transmits an access request to the server status management part 213 when the server 300 specified by the access request is actually accessible will be described.

For example, the switching determination processing part 216 has information to the effect that the server 300 specified by the access request is actually accessible delivered from the server status management part 213. Then, the switching determination processing part 216 delivers the access request to the server access processing part 217. Alternatively, the switching determination processing part 216 has information to the effect that the server 300 specified by the access request is actually inaccessible (for example, “NG”) delivered from the server status management part 213. Then, the switching determination processing part 216 delivers the access request to transmit/receive information to/from the server “A” to the server access processing part 217.

Next, a case in which the switching determination processing part 216 delivers an access request to the proxy access processing part 219 when the server 300 specified by the access request is actually inaccessible will be described.

The switching determination processing part 216 has information to the effect that the server 300 is actually inaccessible delivered from the server status management part 213. In other words, the switching determination processing part 216 has information to the effect that the server “A” is actually inaccessible (for example, “NG”) delivered from the server status management part 213. Then, the switching determination processing part 216 acquires, from the proxy inquiry part 218, “proxy information” to identify the other proxy server 200 that can transfer the access request to the server specified by the access request. To describe concretely, the switching determination processing part 216 delivers an access request to the proxy inquiry part 218. Then, the switching determination processing part 216 has proxy information (for example, proxy information “4”) delivered from the proxy inquiry part 218.

Also, the switching determination processing part 216 delivers the proxy information acquired from the proxy inquiry part 218 and the access request to the proxy access processing part 219.

When information to the effect that an access response from the server 300 is not normal is delivered from the server access processing part 217, the switching determination processing part 216 also acquires proxy information from the proxy inquiry part 218 and delivers the access request and the acquired proxy information to the proxy access processing part 219.

The server access processing part 217 transfers an access request to the server 300. More specifically, when an access request is delivered from the switching determination processing part 216, the server access processing part 217 transfers the access request to the server 300 specified by the access request via the HTTP I/F (proxy server) part 211. For example, the server access processing part 217 has an access request to transmit/receive information to/from the server “A” delivered from the switching determination processing part 216. Then, the server access processing part 217 transfers the access request to the server “A” via the HTTP I/F (proxy server) part 211.

After the access request is transferred via the HTTP I/F (proxy server) part 211, the server access processing part 217 determines whether or not an access response is normally received from the server 300. For example, after the access request is transferred via the HTTP I/F (proxy server) part 211, the server access processing part 217 determines whether or not an access response is delivered within a fixed time. If the server access processing part 217 does not receive the access response within a fixed time, the server access processing part 217 determines that the access response has not been received. The server access processing part 217 delivers information that there is not an access response from the server 300, to the switching determination processing part 216 and the server status management part 213.

More specifically, the server access processing part 217 has an access request transferred from the other proxy server 200 delivered via the HTTP I/F (proxy server) part 211. Then, the server access processing part 217 transfers the access request to the server 300 specified by the access request via the HTTP I/F (proxy server) part 211.

After an access response is received from the server 300, the server access processing part 217 acquires proxy information transmitted together with the access response and server information identifying the server 300 from the access response. Then, the server access processing part 217 delivers the acquired proxy information and server information to the association management part 214.

Also, the server access processing part 217 transfers the access response from the server 300. More specifically, the server access processing part 217 has the access response from the server 300 delivered via the HTTP I/F (proxy server) part 211. Then, the server access processing part 217 delivers the access response to the client 100, which is the destination of the access response, via the HTTP I/F (proxy server) part 211. The server access processing part 217 also delivers server information identifying the server 300, which is the source of the access response, and proxy information transmitted together with the access response to the association management part 214. Also, the server access processing part 217 delivers information to the effect that the access response has been received to the server status management part 213.

The proxy inquiry part 218 acquires, from the association management part 214, proxy information indicating the other proxy server 200 capable of transferring an access request to the server 300 specified by the access request. The proxy inquiry part 218 also delivers “Availability” associated with the association between “Server information” and “Proxy information” stored in the association storage part 201 to the association management part 214.

First, what relates to acquisition of proxy information will be described. The proxy inquiry part 218 has an access request delivered from the switching determination processing part 216. Then, the proxy inquiry part 218 delivers, to the association management part 214, server information identifying the server 300 specified by the delivered access request and information to the effect that an inquiry will be made. Then, the proxy inquiry part 218 acquires proxy information by being delivered from the association management part 214. Then, the proxy inquiry part 218 delivers the acquired proxy information to the switching determination processing part 216.

When “Proxy information” is acquired from the association management part 214, the proxy inquiry part 218 may newly acquire availability by transmitting a confirmation request. The acquisition of availability will be described later. That is, the proxy inquiry part 218 may check whether or not the acquired “Proxy information” is valid when an access request is transferred to the other proxy server 200.

Next, what relates to delivery of “Availability” to the association management part 214 will be described. The proxy inquiry part 218 has an association between “Server information” and “Proxy information” delivered from the association management part 214. Then, the proxy inquiry part 218 transmits a confirmation request about the association to the proxy server 200 (the proxy policy management part 215) identified by the “Proxy information” via the proxy I/F part 212. In other words, the proxy inquiry part 218 checks whether or not the proxy server 200 identified by the delivered “Proxy information” can transfer an access request from the proxy server 200 to the server 300 identified by the delivered “Server information” that the proxy server 200 is a source to transmit a confirmation request.

A concrete example will be provided for a description. It is assumed that the proxy server “1” transmits a confirmation request, and an association between the server information “A” and the proxy information “2” is transmitted from the association management part 214. The proxy inquiry part 218 transmits the confirmation request to the proxy server “2” via the proxy I/F part 212. Here, the proxy inquiry part 218 transmits the confirmation request to check whether or not the proxy information “2” can transfer an access request from the proxy server “1” to the server “A”.

The proxy inquiry part 218 has, for example, a determination result corresponding to the confirmation request delivered from the other proxy server 200 delivered from the proxy server 200 via the proxy I/F part 212. Then, the proxy inquiry part 218 delivers the determination result (“Availability”) corresponding to the delivered confirmation request to the association management part 214. More specifically, the proxy inquiry part 218 delivers, to the association management part 214, information obtained by associating “Availability” with the association between server information and proxy information delivered from the association management part 214.

The proxy access processing part 219 transfers an access request to the other proxy server 200. More specifically, the proxy access processing part 219 has proxy information and an access request delivered from the switching determination processing part 216. Then, the proxy access processing part 219 transfers the delivered access request to the proxy server 200 identified by the delivered proxy information via the HTTP I/F (proxy server) part 211.

### Server

The server 300 is connected to one or a plurality of proxy servers 200 via a network. After an access request from the client 100 transferred through the proxy server 200 is received, the server 300 transmits an access response to the client 100.

The server 300 has a proxy storage part 301.

The proxy storage part 301 accumulates proxy information. For example, as shown in FIG. 6, the proxy storage part 301 associates and stores “Proxy information” and “Update date/time”. To describe concretely by using the example in FIG. 6, the proxy storage part 301 stores an association between the proxy information “1” and the update date/time “2007-07-30T19:17:40 Z”.

Information stored in the proxy storage part 301 is stored by a proxy information management part 312 described later and is also used by the proxy information management part 312 described later.

The first embodiment is described, as shown in FIG. 6, by using a case in which the proxy storage part 301 stores “Update date/time” being associated with “Proxy information”, but the present invention is not limited to this. For example, the proxy storage part 301 may store “Proxy information” only.

Here, a difference between “Proxy information” stored in the proxy storage part 301 and “Proxy information” stored in the association storage part 201 will briefly be described. “Proxy information” stored in the association storage part 201 is a part or all of “Proxy information” stored in the proxy storage part 301. More specifically, information stored in the association storage part 201 is a part or all of “Proxy information” stored in the proxy storage part 301 and an association with “Server information” to identify the server 300 on which the proxy storage part 301 is installed.

The server 300 has an HTTP I/F (server) part 311, a proxy information management part 312, a proxy information attachment part 314, and a service execution part 313. The proxy information management part 312 is an example of a “proxy information storage procedure”. The proxy information attachment part 314 is an example of an “access response transmission procedure”.

The HTTP I/F (server) part 311 receives an access request transferred from the proxy server 200 and delivers the received access request to the proxy information management part 312. When an access response is delivered from the service execution part 313, the HTTP I/F (server) part 311 transmits the access response to the proxy server 200.

The proxy information management part 312 stores proxy information in the proxy storage part 301. More specifically, when an access request transferred from the proxy server 200 is delivered from the HTTP I/F (server) part 311, the proxy information management part 312 stores proxy information identifying the proxy server 200 in the proxy storage part 301. When the proxy information is stored in the proxy storage part 301, the proxy information management part 312 stores “Update date/time” in association with the proxy information.

For example, when an access request transferred from the proxy server “1” is delivered from the HTTP I/F (server) part 311, the proxy information management part 312 stores the proxy information “1” in the proxy storage part 301. When the proxy information “1” is stored in the proxy storage part 301, the proxy information management part 312 stores “2007-07-30T19:17:40 Z” in association with the proxy information “1”.

The proxy information management part 312 also delivers the access response delivered from the HTTP I/F (server) part 311 to the service execution part 313.

The service execution part 313 performs processing in response to an access request. More specifically, the service execution part 313 has an access request delivered from the proxy information management part 312. Then, for example, the service execution part 313 creates content as processing in response to the delivered access request, or executes a service preset on the server 300. Then, the service execution part 313 transmits an access response to the HTTP I/F (server) part 311, the access response which is the processing or the data in response to the delivered access request and is to be transmitted to the client 100.

The proxy information attachment part 314 reads proxy information accumulated in the proxy storage part 301 from the proxy storage part 301 and transmits the read proxy information to the proxy server, which is the source of the access request, together with an access response. More specifically, the proxy information attachment part 314 reads, of proxy information accumulated in the proxy storage part 301, proxy information indicating the proxy server 200 other than the proxy server 200 of the source of the access request. Then, the proxy information attachment part 314 transmits the read proxy information to the proxy server 200, which is the source of the access request, via the HTTP I/F (server) part 311, together with an access response.

For example, an example in which an access response is delivered from the service execution part 313 to the HTTP I/F (server) part 311 and the access response is transmitted from the HTTP I/F (server) part 311 to the proxy server 200 will be described. Here, the proxy information attachment part 314 reads proxy information indicating the proxy server 200 other than the proxy server 200 of the source of the access request from the proxy storage part 301, and attaches the read proxy information to the header of an access response transmitted from the HTTP I/F (server) part 311.

A concrete example of a connection response from the server will be described using the example shown in FIG. 7. As shown in FIG. 7, the proxy information attachment part 314 attaches proxy information to the header of an access response transmitted from the HTTP I/F (server) part 311 (“X-Proxy-List” shown in FIG. 7 applies). In the example shown in FIG. 7, an example in which “vv.vv.vv.vv” and “ww.ww.ww.ww” are attached as proxy information is shown.

### Pathway of an Access Request

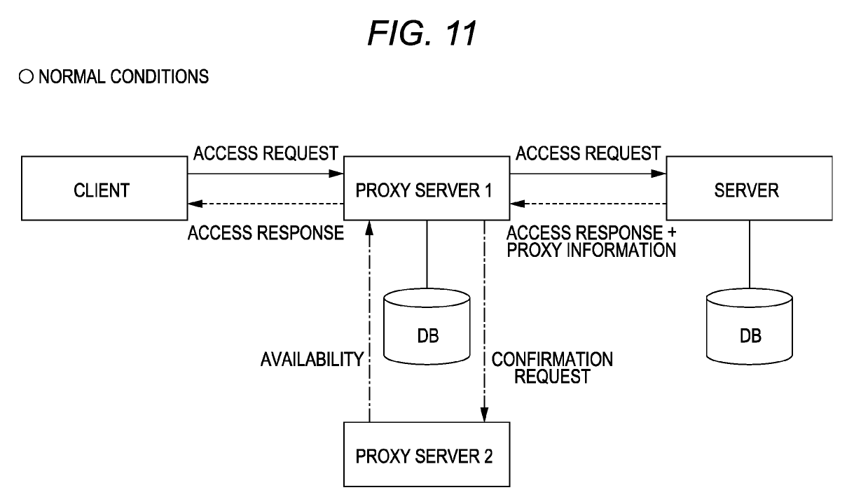

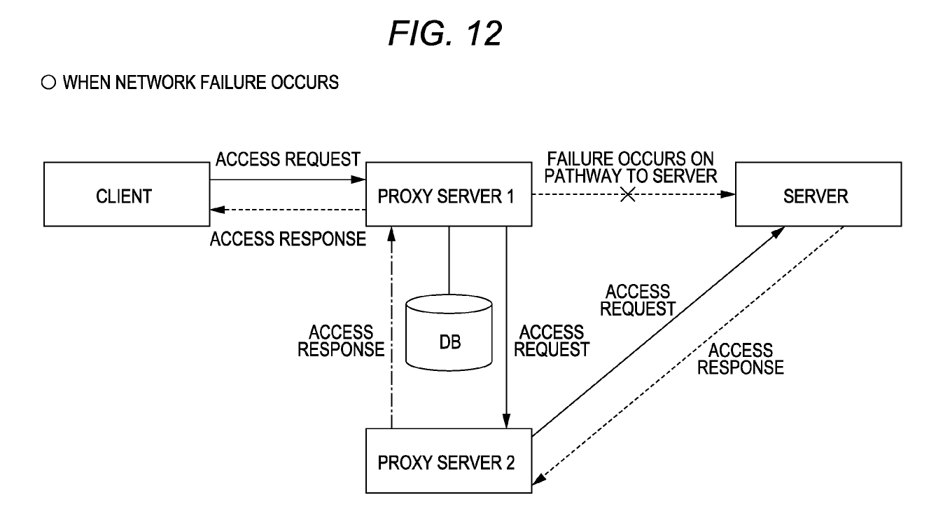

Here, the flow of an access request or access response transmitted/received (transferred) among the client 100, the proxy servers 200, and the server 300 will briefly be described using FIGS. 11 and 12. Here, the flow under normal conditions is first described and then, the flow when a network fails (under abnormal conditions) is described. An example in which the proxy server “1” receives an access request to transmit/receive information to/from the server “A” is taken to describe the flow.

FIGS. 11 and 12 illustrate examples of the flow of information in the first embodiment.

Normal conditions here indicate a case in which the proxy server 200 that receives an access request can transfer the access request to the server 300 specified by the access request. For example, a case in which a network between the proxy server “1” and the server “A” functions normally and the proxy server “1” can actually transfer an access request to the server “A” corresponds to normal conditions.

Abnormal conditions here indicate a case in which the proxy server 200 that receives an access request cannot transfer the access request to the server 300 specified by the access request. For example, a case in which a network between the proxy server “1” and the server “A” does not function normally and the proxy server “1” cannot actually transfer an access request to the server “A” corresponds to abnormal conditions.

Here, the proxy server “1” has an access storage part 202 for recording the status of an accessed server. The server 300 has a proxy storage part 301 for accepting an access request from the various clients 100 and accumulating proxy information identifying the other proxy server 200 capable of accessing the server 300.

First, the flow of information under normal conditions will be described. As shown in FIG. 11, the client 100 transmits an access request to the proxy server “1” (S101). Then, the proxy server “1” transfers the access request to the server 300 (S103). Then, the server 300 transmits an access response and proxy information to the proxy server “1” (S107). Then, the proxy server “1” transfers the access response to the client 100 (S108).

After the access response is transmitted to the client 100, the proxy server “1” acquires a response of “Availability” by transmitting a confirmation request to the proxy server 200 identified by the proxy information transmitted from the server 300.

Next, the flow of information when a network fails will be described. That is, it is assumed that a network between the proxy server “1” and the server 300 fails. As shown in FIG. 12, the client 100 transmits an access request to the proxy server “1” (S201). Here, the proxy server “1” cannot transmit the access request to the server 300. Thus, the proxy server “1” transfers the access request to the other proxy server 200 (the proxy server “2”) (S206). Then, the proxy server “2” transfers the access request to the server 300 (S207).

Then, the server 300 transmits an access response and proxy information to the proxy server “2” (S211). Then, the proxy server “2” transfers the access response to the proxy server “1” (S213). Then, the proxy server “1” transfers the access response to the client 100 (S214).

In this case, the proxy server “1” can manage proxy information in the client 100 by transferring the proxy information to the client 100 together with the access request.

### Processing by an Access Request Transfer System

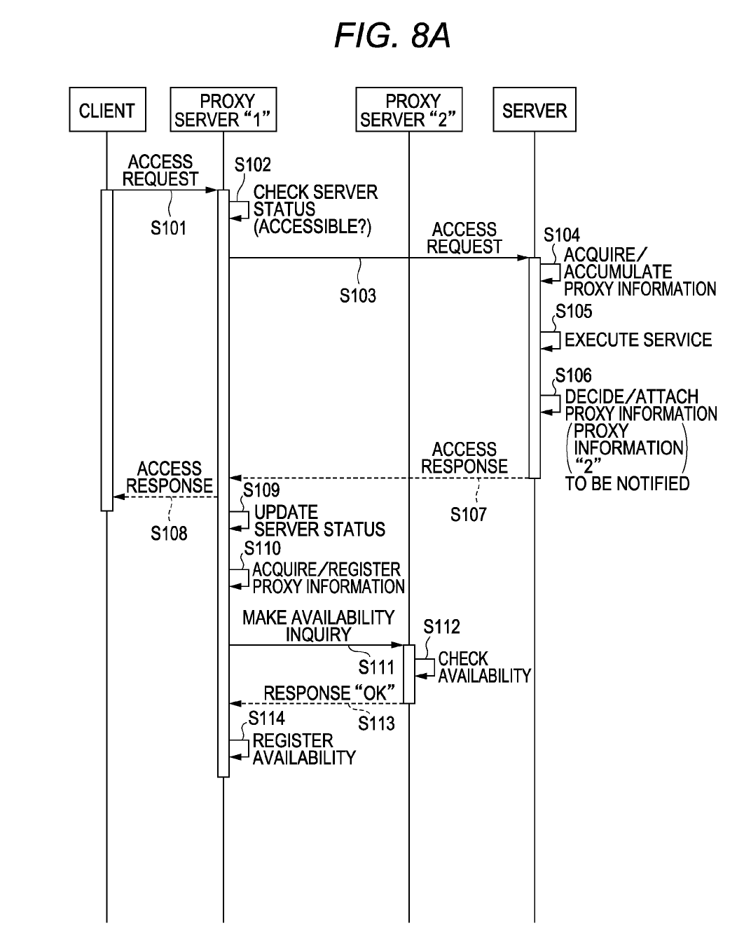

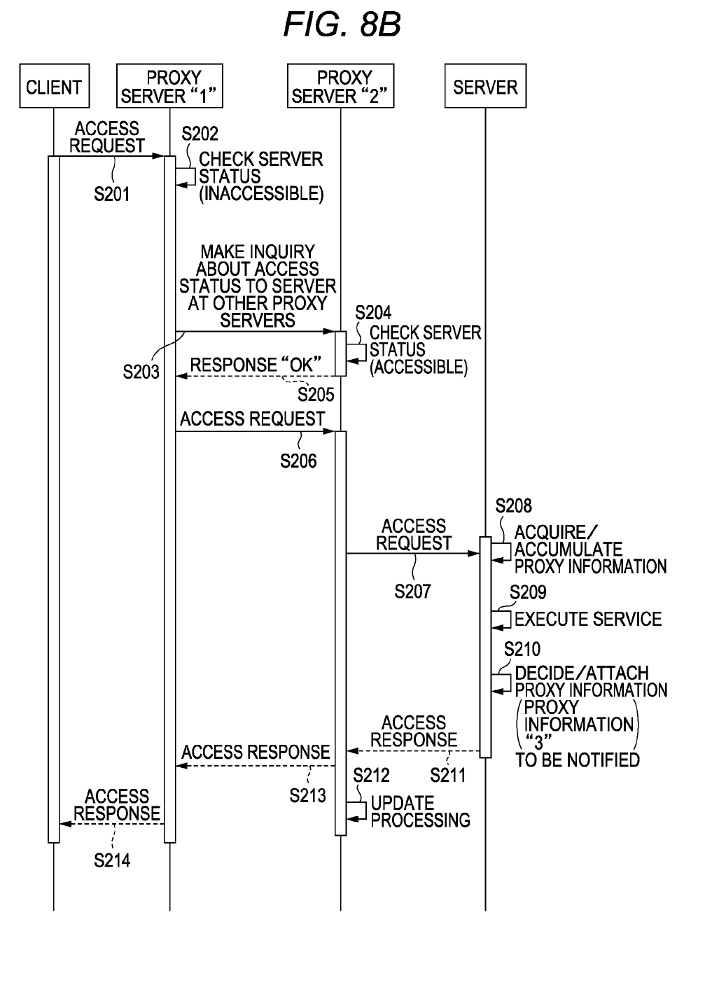

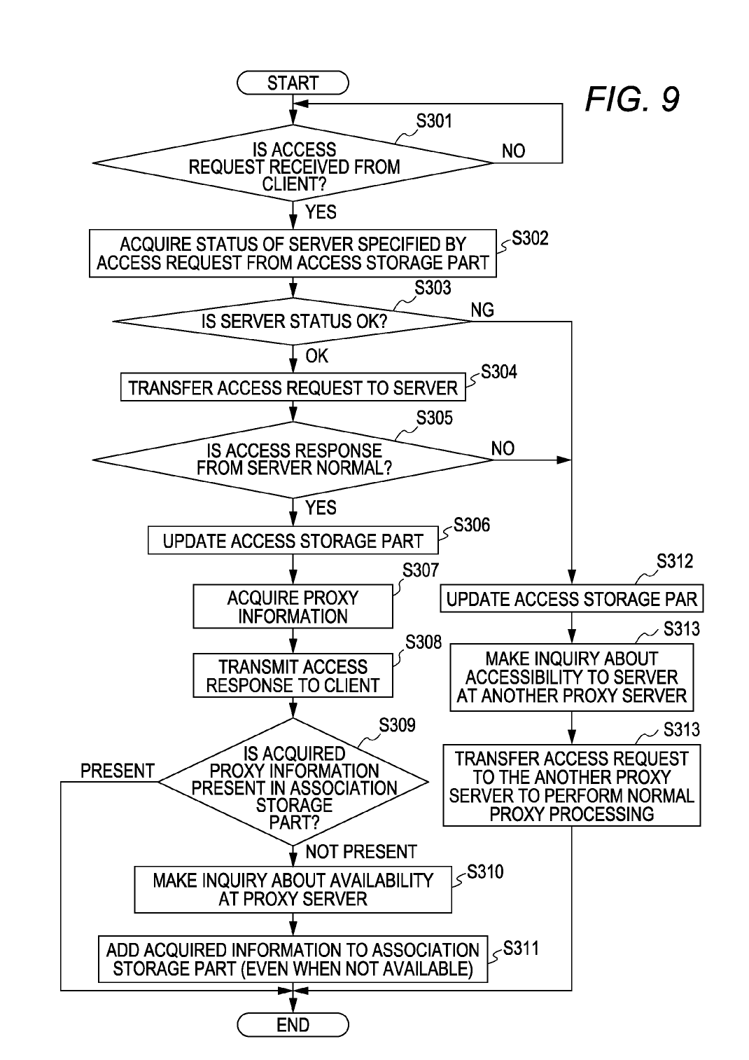

Next, processing by an access request transfer system will be described using FIGS. 8A, 8B and 9. The flow of processing under normal conditions and that under abnormal conditions will first be described below using sequence diagrams (FIGS. 8A and 8B) and then, processing by the proxy server 200 will be described using a flow chart (FIG. 9).

FIG. 8A illustrates an example of the flow of processing by an access request transfer system under normal conditions. FIG. 8B illustrates an example of the flow of processing by the access request transfer system under abnormal conditions. FIG. 9 illustrates an example of the flow of processing of an access request transfer system in the first embodiment.

### Processing Under Normal Conditions

First, the flow of processing by the access request transfer system under normal conditions will be described using FIG. 8A. It is assumed below that the access request transfer system has one client and a plurality of proxy servers (the proxy server “1” and the proxy server “2” in the example of FIG. 8A). It is also assumed that the access request transfer system in the first embodiment has a plurality of servers and an example in which the client transmits an access request that requests transmission/reception of information to/from one of the servers (denoted simply “Server” in the example shown in FIG. 8A) will be described.

As shown in FIG. 8A, the client 100 (the browser 101) transmits an access request to the proxy server “1” 200 via a network (S101). In the example shown in FIG. 8A, for example, the client 100 (the browser 101) transmits an access request to the proxy server “1”.

Then, the proxy server “1” 200 checks the status of the server 300 (S102). More specifically, the proxy server “1” 200 checks whether or not the server 300 is accessible. That is, after the proxy server “1” 200 receives an access request from the client 100, the proxy server “1” 200 that has received the access request determines whether or not the server 300 specified by the access request is in an accessible state.

For example, the proxy server “1” 200 determines whether or not the server status management part 213 stores the status “OK”, which is associated with server information identifying the server 300 specified by the access request, in the access storage part 202. It is assumed that the access storage part 202 stores the status “OK” being associated with server information identifying the server 300 specified by the access request for processing under normal conditions described using FIG. 8A. That is, the proxy server “1” 200 determines that the server 300 is accessible.

Then, the proxy server “1” 200 transfers the access request to the server 300 (S103). That is, if the proxy server “1” 200 determines that the server 300 is actually accessible, the server access processing part 217 transfers the access request to the server 300 specified by the access request via the HTTP I/F (proxy server) part 211.

Then, the server 300 acquires and accumulates proxy information of the proxy server that has transferred the access request (S104). More specifically, after the access request is received from the proxy server “1” 200, the server 300 stores proxy information identifying the proxy server “1” 200 in the proxy storage part 301. After the access request transferred from the proxy server “1” is delivered from the HTTP I/F (server) part 311, the proxy information management part 312 stores the proxy information “1” to identify the proxy server “1” in the proxy storage part 301.

Then, the server 300 executes a service (S105). For example, the service execution part 313 creates content as processing in response to the delivered access request on the server 300 or executes a service preset for the server 300.

Then, the server 300 decides and attaches proxy information to be notified (S106) and transmits an access response (S107). More specifically, the proxy information attachment part 314 reads proxy information accumulated in the proxy storage part 301 from the proxy storage part 301 on the server 300 and transmits the read proxy information to the proxy server “1” 200, which is the source of the access request, together with the access response. The proxy information attachment part 314 on the server 300 reads the proxy information “2” from the proxy storage part 301 and transmits the proxy information “2” to the proxy server “1” via the HTTP I/F (server) part 311 together with the access response.

Then, the proxy server “1” 200 transfers the access response to the client 100 (S108). More specifically, the server access processing part 217 on the proxy server “1” 200 has the access response from the server 300 delivered via the HTTP I/F (proxy server) part 211. Then, the server access processing part 217 delivers the access response to the client 100, which is the destination of the access response, via the HTTP I/F (proxy server) part 211.

Then, the proxy server “1” 200 updates the server status (S109). More specifically, the server status management part 213 on the proxy server “1” 200 associates server information identifying the server specified by the access request and information to the effect that the server is actually accessible for storage in the access storage part 202.

Then, the proxy server “1” 200 acquires and registers the proxy information received from the server (S110110). More specifically, the association management part 214 on the proxy server “1” 200 has the proxy information and server information delivered from the server access processing part 217, and stores an association between the proxy information and server information in the association storage part 201. For example, the association management part 214 stores an association between the server information and the proxy information “2” in the association storage part 201.

Then, the proxy server “1” 200 makes an inquiry about availability of the proxy server “2” (S112). More specifically, on the proxy server “1”, when the association management part 214 stores the association between “Server information” and “Proxy information” “2” in the association storage part 201, the association is delivered to the proxy inquiry part 218. Then, the proxy inquiry part 218 transmits a confirmation request about the association to the proxy server “2” 200 (the proxy policy management part 215) identified by the “Proxy information” via the proxy I/F part 212.

Then, the proxy server “2” 200 that has received the confirmation request from the other proxy server “1” 200 checks whether or not the access request can be transferred (S112). More specifically, on the proxy server “2” that has received the confirmation request from the proxy server “1”, the proxy policy management part 215 determines whether or not the access request from the proxy server “1” is actually transferable from the proxy server “2” to the server 300 specified by the access request.

The proxy policy management part 215 of the proxy server “2” makes a determination using policies stored in the policy storage part 203. The proxy policy management part 215 makes a determination using the association between “Server information” and “Status” stored in the access storage part 202. Then, for example, if two determinations of permission are made, the proxy policy management part 215 determines that the access request can be transferred. That is, the proxy policy management part 215 determines that the availability is “OK”.

Then, the proxy server “2” 200 transmits a response (determination result) to the proxy server “1” (S113). More specifically, the proxy policy management part 215 delivers a determination result (for example, the availability “OK”) to the proxy server “1” via the proxy I/F part 212.

Then, the proxy server “1” 200 that has received the determination result about the confirmation request from the proxy server “2” registers the availability of the proxy server “2” (S114). More specifically, the association management part 214 on the proxy server “1” associates the received “Availability” with the association between “Server information” and “Proxy information” and stores the association in the association storage part 201. For example, the association management part 214 associates the received availability “OK” with the association between “Server information” and “Proxy information” “2” and stores the association in the association storage part 201.

### Processing Under Abnormal Conditions

Next, the flow of processing by the access request transfer system under abnormal conditions will be described using FIG. 8B. A description of the same processing as that under normal conditions is omitted and the flow of processing will briefly be described.

As shown in FIG. 8B, the client 100 (the browser 101) transmits an access request to the proxy server “1” 200 via a network (S201).

Then, the proxy server “1” 200 checks the status of the server 300 (S202). In processing under abnormal conditions described using FIG. 8B, as described above, it is assumed that the access storage part 202 stores the status “NG” being associated with server information identifying the server 300 specified by the access request. That is, the proxy server “1” 200 determines that the server 300 is inaccessible.

Then, the proxy server “1” 200 makes an inquiry about the access status to the server 300 at the other proxy server “2” 200 (S203). That is, the proxy server “1” 200 transmits a confirmation request to the other proxy server “2” 200. To describe by giving an example, the proxy inquiry part 218 on the proxy server “1” 200 delivers, to the association management part 214, server information identifying the server 300 specified by the access request and information to the effect that an inquiry will be made. Then, the proxy inquiry part 218 acquires proxy information delivered by the association management part 214. Then, when “Proxy information” is received from the association management part 214, the proxy inquiry part 218 transmits a confirmation request to the proxy server “2”.

Then, the proxy server “2” 200 checks whether or not the access request can be transferred (S204). The proxy server “2” checks whether or not the access request transferred from the proxy server “1” can be transferred to the server 300. Here, it is assumed that the proxy server “2” can transfer the access request transferred from the proxy server “1”. That is, the proxy server “2” responds with the availability “OK”. Then, the proxy server “2” transmits a response to the proxy server “1”, which is the source of the confirmation request (S205).

Then, the proxy server “1” 200 transfers the access request to the other proxy server “2” 200 that has been confirmed to be able to transfer the access request (S206). More specifically, the proxy access processing part 219 on the proxy server “1” transfers the access request to the proxy server “2”. Then, on the proxy server “2”, which is the destination, the server access processing part 217 transfers the access request transferred from the proxy server “1” to the server 300 specified by the access request (S207).

Then, the server 300 acquires and accumulates proxy information of the proxy server “1” (S208). Subsequently, the server 300 executes a service (S209). Then, the server 300 decides and attaches proxy information to be notified (S210).

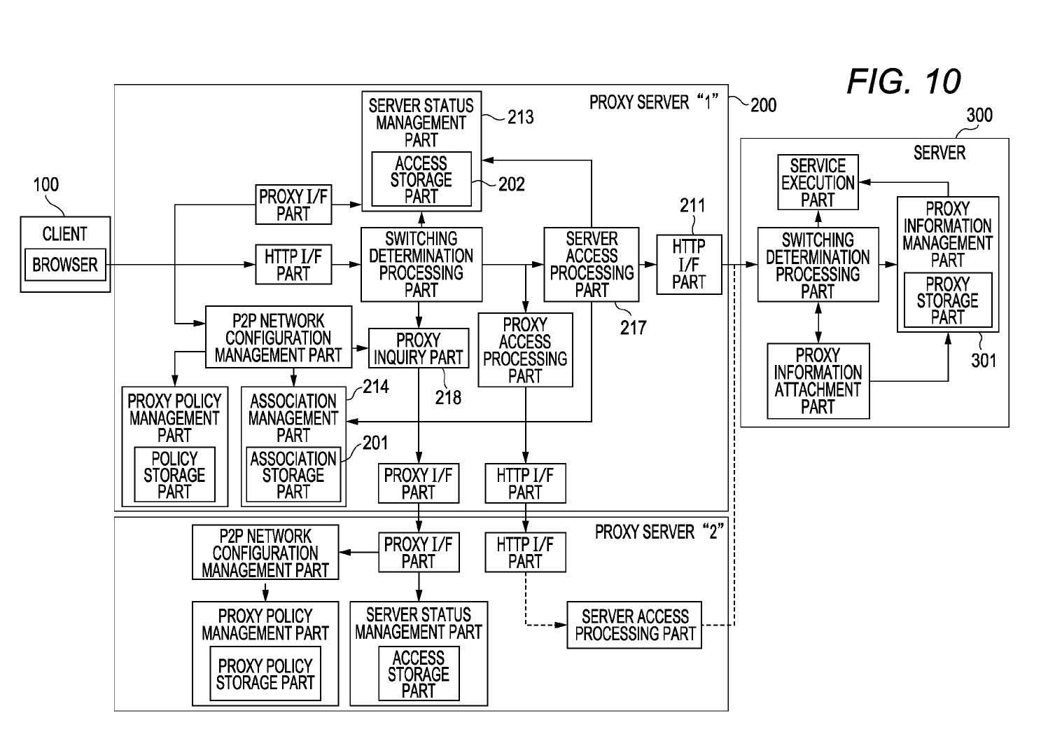

Then, the server 300 transmits an access response to the proxy server “2” (S211). More specifically, on the server 300, an access response is transmitted to the proxy server “2” 200 that has transferred the access request to the server 300. In the example shown in FIG. 10, the server 300 transmits the access response to the proxy server “2”.

Then, the proxy server “2” 200 transfers the access response received from the server 300 to the other proxy server “1” 200, which is the source of the access request. The proxy server “2” transfers the access response received from the server 300 to the other proxy server “1” (S213). The proxy server “2” also performs update processing (S212). More specifically, processing similar to S109 to S114 shown in FIG. 8A is performed.

Then, the proxy server “1” 200 transfers the access response to the client 100 (S214). More specifically, after the access response is received from the proxy server “2”, the proxy server “1” transfers the access response to the client 100.

S201 and S202 shown in FIG. 8B of the processing described above are similar to S101 and S102 shown in FIG. 8A. S208 to S210 shown in FIG. 8B are similar to S104 to S106 shown in FIG. 8A. S212 shown in FIG. 8B is similar to to S114 shown in FIG. 8A.

### Processing by the Proxy Server

Next, processing of the proxy server 200 will be described using FIG. 9. As shown in FIG. 9, when an access request is received from the client 100 on the proxy server 200 (S301, Yes), the server status management part 213 acquires the status of the server 300 specified by the access request from the access storage part 202 (S302). More specifically, the server status management part 213 acquires “Status” associated with server information identifying the server 300 specified by the access request from the access storage part 202 to determine whether or not the server 300 is actually accessible. That is, the server status management part 213 determines whether or not the server status is “OK” (S303).

Here, if the server status is determined to be “OK” by the server status management part 213 (S303, Yes), the server access processing part 217 on the proxy server 200 transfers the access request to the server 300 via the HTTP I/F (proxy server) part 211 (S304). For example, the proxy server “1” transfers the access request to the server 300 via the HTTP I/F (proxy server) part 211.

Then, the proxy server 200 determines whether or not an access response has been received from the server 300 (S305). More specifically, the server access processing part 217 on the proxy server 200 determines whether or not an access response is delivered within a fixed time after the access request is transferred via the HTTP I/F (proxy server) part 211.

Here, if it is determined that an access response has been received from the server 300 (S305, Yes), the proxy server 200 updates the access storage part (S306). More specifically, the server status management part 213 updates “Status” associated with the server 300 to “OK”.

Then, the proxy server 200 acquires proxy information (S307). That is, after the access response is received from the server 300, the server access processing part 217 on the proxy server 200 acquires proxy information and server information identifying the server 300 transmitted together with the access response. Then, the server access processing part 217 delivers the proxy information and server information to the association management part 214.

Then, the proxy server 200 delivers the access response to the client 100 (S308).

Also, the association management part 214 on the proxy server 200 checks whether or not the association containing the acquired proxy information is present (stored) in the association storage part 201 (S309). Here, if the association is present in the association storage part 201 (S309, Yes), the association management part 214 terminates processing.

On the server 300, on the other hand, if the association is not present in the association storage part (S309, No), the association management part 214 makes an inquiry about availability (S310). That is, the association management part 214 delivers the acquired proxy information and server information identifying the server 300 showing the source of the access response to the proxy inquiry part 218. Then, the proxy inquiry part 218 transmits a confirmation request to the proxy server 200 identified by the proxy information.

Then, the association management part 214 on the proxy server 200 associates the proxy information and a determination result (“Availability”) to the confirmation request and stores (adds) the association in (to) the association storage part 201 (S311). Here, even if, for example, the availability “NG” is received as a determination result to the confirmation request, the association management part 214 stores proxy information and a determination result to the confirmation request in the association storage part 201.

If, at S305 described above, it is determined that an access response has not been received from the server (S305, No), the proxy server 200 updates the access storage part (S312). More specifically, the server status management part 213 on the proxy server 200 updates “Status” associated with the server 300 to “NG”.

If the access storage part 202 is updated (S312) after it is determined that the status of the server 300 is not “OK” (S303, No) or an access response has not normally been received from the server (S305, No), the proxy server 200 makes an inquiry about the other proxy server 200 that can transfer the access request (S313). That is, the association management part 214 on the proxy server 200 acquires, from the association storage part 201, “Proxy information” identifying another proxy server that can actually access the server specified by the access request.

Then, the proxy server 200 transfers the access request to the other proxy server 200 identified by the acquired proxy information and performs normal proxy processing (for example, S305 to S311)(S314).

### Effect of the First Embodiment

Clients in an enterprise have normally used services (Web content, Web applications, Web services and the like) on servers outside the organization to which the clients belong via proxy servers. If it becomes impossible for such servers to perform communication due to a network failure, even if the servers themselves are normal, services themselves provided by such servers also become unavailable.

Here, a network from clients to a proxy server is managed by an organization to which users belong and thus, even if the network fails, the failure can relatively swiftly be repaired. However, a network from the proxy server to servers is not managed by an organization to which users belong or service providers and thus, when a failure occurs, it is generally difficult to repair the failure. As a result, services may not be available for a long time, hindering business operations.

In such cases, making servers accessible by using other pathways is more beneficial than restoring the network because users can continuously use servers. Large enterprises may have a plurality of proxy servers to have access to a plurality of different networks and while a server cannot be reached via some proxy server, the server may be accessed via another proxy server. That is, when some server is not available to users, the server may become available by using another proxy server.

For example, a technique to use a script (program) to automatically change (switch) the proxy server 200 used by the client has been known. More specifically, according to this technique, when the administrator executes a script, the script rewrites setting information about the proxy server preset to the browser of the client or selects and sets the proxy server in accordance with the network to be used.

However, according to such a conventional technique, it is necessary for the administrator to preset all setting information showing under which conditions to use the proxy server. In addition, the administrator needs to maintain setting information.

Further, such a conventional technique does not include a function to change the proxy server in accordance with the access status to the server. Thus, it is necessary for the administrator to search for a proxy server that can access the server and change settings of the client so that the server is accessed by using the proxy server obtained after searching and thus, it is necessary to manually change the proxy server to be used by the client.

Also, an add-on to automatically switch the proxy for each URL has been used by specific browsers (for example, FoxyProxy for Mozilla FireFox). However, according to such a conventional technique, advance settings of setting information to pairs of the URL pattern and proxy server cannot be automatically switched to settings in accordance with management or the access status.

In consideration of communication loads of a plurality of proxy servers, there is known a technique to dynamically change the proxy server used for response processing when access is requested by the client without settings of the server and client being changed. However, according to this technique, it is necessary to preset the proxy server to be switched, increasing the load on the administrator of the proxy server. Also, according to this technique, the trigger of switching the proxy server is an increase in communication load of the proxy server, and only the proxy server to process responses from the server is switched. Thus, according to this technique, unavailability of the server due to a network failure cannot be avoided.

According to conventional technology, the administrator searches for the proxy server that can access the server after a network failure occurs and the administrator changes settings of the client so that the server is accessed using a proxy server obtained by searching. Thus, when the network failure occurs, a long time is needed before the server can be accessed again.

In contrast to such conventional technology, according to the first embodiment, the server can be accessed from another proxy server without settings of the client being changed.

Also, according to the first embodiment, it is possible to swiftly determine whether or not the server 300 specified by an access request can be accessed.

Also, according to the first embodiment, it is possible to determine whether or not the server 300 can actually be accessed even if whether or not the server 300 can actually be accessed is not stored in the access storage part 202.

Also, according to the first embodiment, it is possible to swiftly determine which association of the associations stored in the association storage part 201 is valid.

Also, according to the first embodiment, it is possible to transmit only proxy information that has a possibility of being used.

For example, even if proxy information identifying the proxy server 200 (“1”) is transmitted to the proxy server 200 (“1”), the proxy server 200 (“1”) that has received the proxy information will not use the received proxy information. According to the first embodiment, it becomes possible to not transmit proxy information that has no possibility of being used but to transmit only proxy information that has a possibility of being used.

According to a disclosed access request transfer system, a server can be accessed from another proxy server without settings of a client being changed.

### Second Embodiment

So far, as the first embodiment, techniques to individually transmit a confirmation request from the proxy server 200 to the other proxy server 200 have been described, but the present invention is not limited to such techniques. For example, a P2P (peer-to-peer) network may be constructed with the other proxy server 200.

More specifically, in an access request transfer system according to a second embodiment, when the proxy server 200 receives proxy information together with an access response, the proxy server 200 constructs a peer-to-peer network between the proxy server 200 identified by the proxy information and the other proxy server 200 received the access response. Then, the proxy server 200 transmits a confirmation request via the constructed peer-to-peer network and transmits a determination result via the peer-to-peer network.

Thus, as the second embodiment, a technique to construct and use a peer-to-peer network will be described using FIG. 10. What is similar to the access request transfer system in the first embodiment will briefly be described or omitted below. FIG. 10 illustrates an example of the configuration of an access request transfer system according to the second embodiment.

As shown in FIG. 10, an access request transfer system according to the second embodiment additionally has a P2P network configuration management part. The P2P network configuration management part manages the topology (connection mode of a computer network) of the P2P network. More specifically, the P2P network configuration management part manages a peer relationship established between the proxy servers 200 and the other proxy server 200. A P2P network managed by the P2P network configuration management part is used, for example, when the proxy inquiry part 218 transmits a confirmation request. Alternatively, a P2P network is used when a determination result of the confirmation request is transmitted by the proxy inquiry part 218.

More specifically, when a new association between “Proxy information” and “Server information” is notified from the association management part 214, the P2P network configuration management part determines whether or not to establish a peer relationship with the other proxy server 200 corresponding to “Proxy information”. Then, the P2P network configuration management part constructs a P2P network to update the structure of the P2P network.

When it is determined whether or not to establish a peer relationship, the P2P network configuration management part determines to establish a peer relationship, for example, when the proxy server 200 is the quickest to respond or the proxy server 200 is near in terms of a network.

When a confirmation request is transmitted, for example, the proxy server 200 (the proxy inquiry part 218) refers to a P2P network managed by the P2P network configuration management part to transmit the confirmation request to the other proxy server 200 in a peer relationship from the proxy I/F part via the P2P network.

When the confirmation request is received, the proxy server 200 that has received an inquiry of the confirmation request from the proxy I/F part via the P2P network may relay the confirmation request to the other proxy server 200 in a peer relationship to transmit an obtained result to the proxy server 200, which is the source of the confirmation request.

A P2P network managed by the P2P network configuration management part may be used for other uses, in addition to transmission of a confirmation request. For example, the P2P network may be used to notify the other proxy server 200 of access conditions to the actually accessed server 300.

More specifically, the proxy server 200 receives an access response responding to an access request from the server. Then, the proxy server 200 notifies the other proxy server of an association among proxy information identifying the proxy server that has received the access response, server information identifying the server 300 specified by the access request, and information to the effect that the server 300 is actually accessible via a peer-to-peer network.

The proxy server 200 notified of the association via the peer-to-peer network stores the association among proxy information, the server information and the information to the effect that the server 300 is actually accessible in the association storage part 201.

To describe by taking a concrete example, the proxy server 200 updates access conditions for the server status management part 213 and at the same time, the proxy inquiry part 218 notifies the proxy server 200 in a peer relationship of the access conditions when receiving an access response from the server 300. The proxy inquiry part 218 notifies the other proxy server 200 in a peer relationship of “Proxy information” to identify the proxy server 200 on which the proxy inquiry part 218 is installed, “Server information” to identify the server to which the access response is transmitted, and “Status”.

### Effect of the Second Embodiment

According to the second embodiment, as described above, access conditions can be checked via a peer-to-peer network without making an inquiry individually at the other proxy servers. Accordingly, searching for an alternative proxy server can be made more efficient.

Also, according to the second embodiment, information to the effect that a server is actually accessible can easily be shared among a plurality of proxy servers by using a peer-to-peer network.

### Third Embodiment

Embodiments of the present invention have been described, but various other embodiments of the present invention than those described above may also be carried out. Thus, such other embodiments will be described below.

### Determination Method

The first and second embodiments do not mention a case in which “Server information” to identify the server specified by an access request is not stored in the access storage part 202, but the present invention is not limited to this. More specifically, the access storage part 202 on the proxy server 200 may not store “Server information” to identify the server specified by an access request in the access storage part 202.

For example, the proxy server 200 determines whether or not an association containing “Server information” to identify the server in order to determine whether or not the server is actually accessible is stored in the access storage part 202.

Here, if, for example, the proxy server 200 determines that an association containing “Server information” to identify the server to determine whether or not actually accessible is stored in the access storage part 202, the proxy server 200 performs determination processing using the access storage part 202. If, on the other hand, the proxy server 200 determines that no association containing “Server information” to identify the server to determine whether or not actually accessible is stored in the access storage part 202, the proxy server 200 actually transfers data (for example, an access request) to the server 300 to determine whether or not the server 300 is actually accessible.

Then, if an access response to the transferred data (for example, the access request) is actually received from the server 300, the proxy server 200 determines that the server 300 is actually accessible. If, on the other hand, no access response to the transferred data (for example, the access request) is actually received from the server 300, the proxy server 200 determines that the server 300 is actually inaccessible.

A concrete example will be described using a case in which the access storage part 202 stores only associations containing server information “A”, “B”, and “C”. When a determination about server information “D” is made, the proxy server 200 determines that no association containing the server information “D” is stored in the access storage part 202. Then, the proxy server 200 actually transfers an access request to a server “D”. Then, if the proxy server 200 receives an access response to the transferred access request from the server “D”, the proxy server 200 determines that the server “D” is actually accessible. If, on the other hand, the proxy server 200 receives no access response to the transferred access request from the server “D” (for example, if no access response is received within a predetermined time after the access request is transferred), the proxy server 200 determines that the server “D” is actually inaccessible.

At this point, determination processing may be decided using “Update date/time”. For example, whether or not “Update date/time” is within a preset threshold may be determined and if “Update date/time” is within a preset threshold, a determination is made using the access storage part 202 and if “Update date/time” is not within a preset threshold, a determination is made by actually transmitting data.

### Determination Technique

In the first and second embodiments, a confirmation request is transmitted by the proxy server 200 each time an association between “Server information” and “Proxy information” is stored in the association storage part 201, but the present invention is not limited to this. For example, when an access request is actually transferred to the other proxy server 200, the proxy server 200 may acquire “Availability” by transmitting a confirmation request.

### Proxy Information Transmitted by the Server

The first and second embodiments have been described for a case in which proxy information identifying the proxy server 200 other than the proxy server 200 that has transferred an access request is used as proxy information transmitted from the server 300 to the proxy server 200, but the present invention is not limited to this. For example, the server 300 may transmit all proxy information accumulated in the proxy storage part 301.

The server 300 may have a policy for selecting proxy information to be transmitted in advance so that proxy information to be transmitted to the proxy server 200 is selected according to the policy. To describe by taking a concrete example, the server 300 may select three pieces of proxy information having the three shortest Hamming distances from the address of the proxy server 200 serving as the source of the access request, the most recently accessed proxy information (the latest “Update date/time”) or proxy information having an overlapped domain when FQDN (Fully Qualified Domain Name) is viewed. The server 300 may also select proxy information whose class (for example, the class of IP address) is the same as that of the proxy server, which is the source of the access request.

### Access Request Transfer System Configuration

The first and second embodiments do not mention a case in which the client 100 transmits an access request directly to the server 300 without the proxy server 200, but the present invention is not limited to this. For example, the present invention can be carried out in a case in which an access request is transmitted to the server 300 via the proxy server 200, and in a case in which an access request is transmitted to the server 300 without the proxy server 200. In such a case, for example, after an access request is received, the server 300 determines whether or not the access request is an access request via the proxy server 200. The server 300 makes a determination, for example, by examining User-Agent information of the access request to see whether or not any name of the proxy server 200 product such as Squid and DeleGate is contained. Then, if it turns out that the access request is an access request via the proxy server 200, the server 300 stores proxy information identifying the proxy server 200 in the proxy storage part 301.

### Update

The first and second embodiments do not mention a technique to periodically update information (such as “Status” and “Availability”) stored in storage parts by each of the proxy servers 200, but the present invention is not limited to this. For example, the proxy server 200 may periodically acquire “Status” and “Availability” to update such information by referring to a timer to periodically exchange status information of the server with the other proxy server 200 and to retry access to the server 300.

At this point, information indicating the type of network failure such as “Network Unreachable” indicating that a network failure has occurred or “Timeout” indicating a timeout may be stored as “Status”.

### Access Request Transfer

The first and second embodiments do not mention a case in which, when an access request is transferred, the other proxy server 200 to which the access request is transferred is not present, but the present invention is not limited to this. For example, when the other proxy server 200 to which the access request is transferred is present, the proxy server 200 transfers the access request. When the other proxy server 200 to which the access request is transferred is not present, the proxy server 200 may transmit an error (information to the effect that the access request cannot be transmitted to the server 300) to the client 100.

### Combination of Embodiments

In the first embodiment, when a technique to transfer an access request to the other proxy server 200 is described, (1) a technique to decide the access transfer destination by storing server information and “Status” and using “Status”, (2) a technique, when there is no association of a server specified by an access request, to transfer the access request to the server, (3) a technique to check whether or not the other proxy server 200 is permitted to access the server, and (4) a technique to transmit “Proxy information” by the server 300 to identify the proxy server 200 other than the source of the access request have been also described together. In the second embodiment, (5) a technique to transmit/receive information between the proxy servers 200 using a peer-to-peer network and (6) a technique to notify the other proxy server 200 of information via the peer-to-peer network have been also described together.

However, embodiments of the present invention are not limited to these embodiments. For example, one or a plurality of techniques described above in (1) to (6) may be combined.

### System Configuration

Unless otherwise specified, processing procedures, control procedures, concrete names, and information including various kinds of data and parameters shown above or in the drawings (for example, FIGS. 1 to 12) can arbitrarily be changed.

Each component of each illustrated device is functionally conceptual and need not necessarily be configured physically as illustrated. That is, the concrete configuration of distribution/integration of each device is not limited to the illustrated configuration and all or a part thereof may be configured by functional or physical distribution/integration in arbitrary units in accordance with various loads or usage. For example, each part of the proxy server 200 or the server 300 may be integrated or distributed if appropriate. For example, the proxy policy management part 215, the server status management part 213, and the association management part 214 may be integrated.

In the first and second embodiments, it is assumed that each of the plurality of proxy servers 200 in an access request transfer system has a similar function, but the present invention is not limited to this. For example, the proxy server 200 having the configuration parts shown in FIG. 2 and the proxy server 200 having no configuration parts shown in FIG. 2 may coexist.

### Program

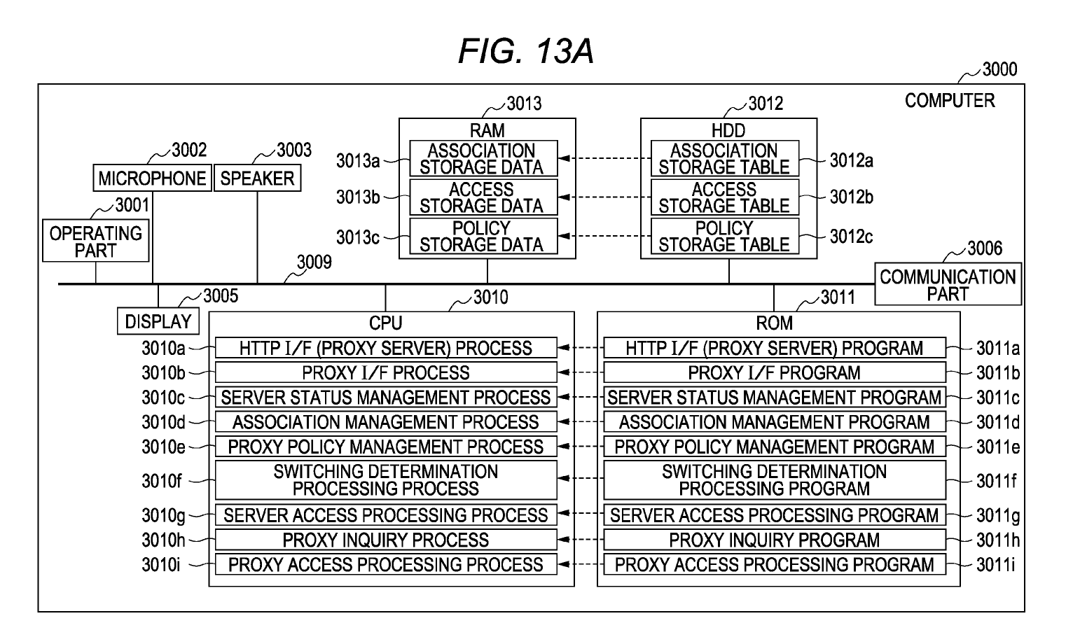

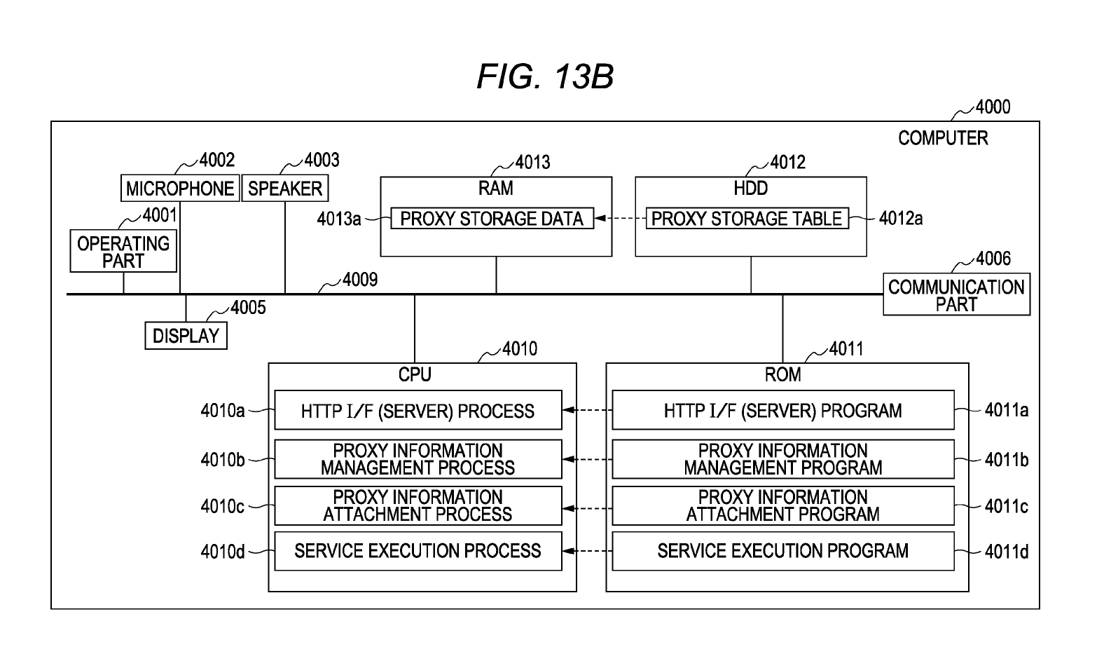

Various kinds of processing described in the above embodiments can be realized by executing prepared programs on a personal computer or workstation. Thus, an example of a computer executing an access request transfer program having functions similar to those of the above embodiments will be described using FIG. 13.

A computer executing a program to function as the proxy server 200 of an access request transfer system is first described below using FIG. 13A and then, a computer executing a program to function as the server 300 of an access request transfer system is described using FIG. 13B. FIGS. 13A and 13B illustrate programs of an access request transfer system according to the first embodiment.

### Programs Functioning as a Proxy Server

First, programs to function as the proxy server 200 of an access request transfer system will be described. As shown in FIG. 13A, a computer 3000 is configured by connecting an operating part 3001, a microphone 3002, a speaker 3003, a display 3005, a communication part 3006, a CPU 3010, a ROM 3011, an HDD 3012, and a RAM 3013 by a bus 3009 or the like.

The ROM 3011 has control programs executing functions similar to the HTTP I/F (proxy server) part 211, the proxy I/F part 212, the server status management part 213, the association management part 214, the proxy policy management part 215, the switching determination processing part 216, the server access processing part 217, the proxy inquiry part 218, and the proxy access processing part 219 shown in the first embodiment, that is, as shown in FIG. 13A, an HTTP I/F (proxy server) program 3011a, a proxy I/F program 3011b, a server status management program 3011c, an association management program 3011d, a proxy policy management program 3011e, a switching determination processing program 3011f, a server access processing program 3011g, a proxy inquiry program 3011h, and a proxy access processing program 3011i stored in advance respectively. These programs 3011a to 3011i may be, like each component of the proxy server 200 of the access request transfer system shown in FIG. 2, integrated or separated as appropriate.

When the CPU 3010 executes these programs 3011a to 3011i by reading from the ROM 3011, as shown in FIG. 13A, each of the programs 3011a to 3011i will operate as an HTTP I/F (proxy server) process 3010a, a proxy I/F process 3010b, a server status management process 3010c, an association management process 3010d, a proxy policy management process 3010e, a switching determination processing process 3010f, a server access processing process 3010g, a proxy inquiry process 3010h, and a proxy access processing process 3010i respectively. Each of the processes 3010a to 3010i corresponds to the HTTP I/F (proxy server) part 211, the proxy I/F part 212, the server status management part 213, the association management part 214, the proxy policy management part 215, the switching determination processing part 216, the server access processing part 217, the proxy inquiry part 218, and the proxy access processing part 219 shown in FIG. 2, respectively.

The HDD 3012 is provided with an association storage table 3012a, an access storage table 3012b, and a policy storage table 3012c. Each of the tables 3012a to 3012c corresponds to the association storage part 201, the access storage part 202, and the policy storage part 203, respectively.

The CPU 3010 reads information from the association storage table 3012a, the access storage table 3012b, and the policy storage table 3012c to store the information in the RAM 3013 and executes the access request transfer program using association storage data 3013a, access storage data 3013b, and policy storage data 3013c stored in the RAM 3013.

### Programs Functioning as a Server

Next, programs to function as the server 300 of an access request transfer system will be described. As shown in FIG. 13B, a computer 4000 is configured by connecting an operating part 4001, a microphone 4002, a speaker 4003, a display 4005, a communication part 4006, a CPU 4010, a ROM 4011, an HDD 4012, and a RAM 4013 by a bus 4009 or the like.

The ROM 4011 has control programs executing functions similar to the HTTP I/F (server) part 311, the proxy information management part 312, the proxy information attachment part 314, and the service execution part 313 shown in the first embodiment, that is, as shown in FIG. 13B, an HTTP I/F (server) program 4011a, a proxy information management program 4011b, a proxy information attachment program 4011c, and a service execution program 4011d stored in advance respectively. These programs 4011a to 4011d may be, like each component of the server 300 of the access request transfer system shown in FIG. 2, integrated or separated as appropriate.

When the CPU 4010 executes these programs 4011a to 4011d by reading from the ROM 4011, as shown in FIG. 13B, each of the programs 4011a to 4011d will operate as an HTTP I/F (server) process 4010a, a proxy information management process 4010b, a proxy information attachment process 4010c, and a service execution process 4010d, respectively. Each of the processes 4011a to 4011d corresponds to the HTTP I/F (server) part 311, the proxy information management part 312, the proxy information attachment part 314 and the service execution part 313 shown in FIG. 2, respectively.

The HDD 4012 is provided with a proxy storage table 4012a. The table 4012a corresponds to the proxy storage part 301 shown in FIG. 2.

The CPU 4010 reads information from the proxy storage table 4012a to store the information in the RAM 4013 and executes the access request transfer program using proxy storage data 4013a stored in the RAM 4013.

What is claimed is:

1. A computer-readable recording medium that stores therein an access request transfer program for access request transfer, the access request transfer transferring an access request transmitted from a client to a server specified as an access destination by the access request in a network including at least first and second proxy servers that can receive the access request from the client, the program causing the first proxy server to execute:
an association storage procedure for storing server information into an association storage unit, when proxy information identifying the first proxy server is received together with an access response responding to the access request from the specified server or the second proxy server, the server information identifying the server specified by the access request and the proxy information by associating the server information and the proxy information;
a determination procedure for determining, when an access request is received from the client, whether or not the first proxy server that has received the access request can actually access the server specified by the access request;
a first access request transfer procedure for transferring the access request to the second proxy server identified by the proxy information stored by being associated with the server information and other than the first proxy server that has received the access request after the association storage unit is searched using the server information identifying the server specified by the access request when the server is determined to be actually inaccessible by the determination procedure; and
a second access request transfer procedure for transferring the access request to the server specified by the access request when the server is determined to be actually accessible through the first server by the determination procedure.

2. The computer-readable recording medium according to claim 1, the program further causing the first proxy server to execute:
an access information storage procedure for associating the server information identifying the server specified by the access request and information to the effect that the server is actually accessible and storing the server information and the information in an access storage unit when the access response responding to the access request is received from the server,
wherein, when the access request is received, the determination procedure determines whether or not information to the effect that the server is actually accessible is stored in the access storage unit by being associated with the server information showing the server specified by the access request and, if the information to the effect that the server is actually accessible is stored, the determination procedure determines that the server is actually accessible, and if the information to the effect that the server is actually accessible is not stored, the determination procedure determines that the server is actually inaccessible.

3. The computer-readable recording medium according to claim 2, wherein when no association containing the server information showing the server specified by the access request is stored in the access storage unit, the determination procedure transfers the access request to the server specified by the access request to determine whether or not the server is actually accessible.

4. The computer-readable recording medium according to claim 1, the program further causing the first proxy server to execute:
a confirmation request transmission procedure for transmitting a confirmation request, which is a request to check whether or not the first proxy server can actually transfer the access request to the server specified by the access request, to the first proxy server identified by the proxy information and other than the first proxy server that has received the access request when the proxy information is received together with the access response responding to the access request; and
a determination result storage procedure for storing, when a determination result corresponding to the confirmation request transmitted by the confirmation request transmission procedure is received from the second proxy server, the received determination result in the association storage unit in association with an association between the server information showing the server to which whether or not the access request is actually transferable is checked based on the confirmation request and the proxy information showing the second proxy server,
a confirmation request determination procedure for determining whether or not the first proxy server that has received the confirmation request from the second proxy server is actually accessible to the server specified by the access request; and
a determination result transmission procedure for transmitting the determination result determined by the confirmation request determination procedure to the first proxy server, which is the source of the confirmation request,
wherein the first access request transfer procedure transfers the access request to the proxy server associated with the determination result that the access request can actually be transferred.

5. The computer-readable recording medium according to claim 1, wherein the access response transmission procedure reads the proxy information showing the second proxy server other than the first proxy server of the source of the access request from the proxy information accumulated in the proxy storage unit and transmits the read proxy information together with the access response.

6. The computer-readable recording medium according to claim 4, the program further causing the first proxy server to execute:
a construction procedure for constructing a peer-to-peer network with the first proxy server that is identified by the proxy information and other than the first proxy server that has received the access request when the proxy information is received together with the access response,
wherein the confirmation request transmission procedure transmits the confirmation request via the peer-to-peer network constructed by the construction procedure, and
wherein the determination result transmission procedure transmits the determination result via the peer-to-peer network.

7. The computer-readable recording medium according to claim 4, the program further causing the first proxy server to execute:
a construction procedure for constructing a peer-to-peer network with the first proxy server that is identified by the first proxy information and other than the proxy server that has received the access request when the proxy information is received together with the access response; and
a notification procedure for notifying the second proxy server of the association among the proxy information identifying the first proxy server that has received the access response, the server information identifying the server specified by the access request, and information to the effect that the server is actually accessible, via the peer-to-peer network when the access response responding to the access request is received from the server,
a post-notification storage procedure for storing the association among the proxy information, the server information, and the information to the effect that the server is actually accessible notified by the notification procedure in the association storage unit.

8. An access request transfer system that transfers an access request transmitted from a client to a server specified by the access request as an access destination in a network containing at least first and second proxy servers, the system comprising:
the first proxy server receiving the access request from the client and having an association storage unit, a determination unit, a first access request transfer unit, and a second request transfer unit; and
the server having a proxy information storage unit and an access response transmission unit,
wherein, when proxy information identifying the proxy server is received from the server or the second proxy server together with an access response responding to the access request, the association storage unit stores server information identifying the server specified by the access request and the proxy information in an association storage unit by associating the server information and the proxy information,
wherein, when the access request is received from the client, the determination unit determines whether or not the first proxy server that has received the access request can actually access the server specified by the access request,
wherein, when the server is determined to be actually inaccessible by the determination unit, the first access request transfer unit searches the association storage unit using the server information identifying the server specified by the access request and transfers the access request to the second proxy server that is identified by the proxy information stored by being associated with the server information and other than the first proxy server that has received the access request,
wherein, when the server is determined to be actually accessible by the determination unit, the second access request transfer unit transfers the access request to the server specified by the access request,
wherein, when the access request transferred by the second access request transfer unit is received from the first proxy server, the proxy information storage unit stores the proxy information identifying the proxy server in a proxy storage unit accumulating the first proxy information, and
wherein the access response transmission unit reads the proxy information accumulated in the proxy storage unit from the proxy storage unit and transmits the read proxy information to the first proxy server, which is a source of the access request, together with the access response responding to the access request.

9. An access request transfer method for transferring an access request transmitted from a client to a server specified by the access request as an access destination in a network containing at least first and second proxy servers, the method comprising:
an association storage step of storing, when first proxy server receives the access request from the client receives proxy information identifying the proxy server from the server or the second proxy server together with an access response responding to the access request, server information identifying the server specified by the access request and the proxy information by associating the server information and the proxy information;
a determination step of determining, when the first proxy server receives the access request from the client, whether or not the first proxy server that has received the access request can actually access the server specified by the access request;
a first access request transfer step by the first proxy server of transferring the access request to the second proxy server identified by the proxy information stored by being associated with the server information and other than the first proxy server that has received the access request after the association storage unit is searched using the server information identifying the server specified by the access request when the server is determined to be actually inaccessible by the determination step;
a second access request transfer step by the first proxy server of transferring the access request to the server specified by the access request when the server is determined to be actually accessible by the determination step;
a proxy information storage step by the server of storing the proxy information identifying the first proxy server in a proxy storage unit accumulating the proxy information when the access request transferred by the second access request transfer step is received from the first proxy server; and
an access response transmission step by the server of reading the proxy information accumulated in the proxy storage unit from the proxy storage unit and transmitting the read proxy information to the second proxy server, which is a source of the access request, together with the access response responding to the access request.
